(19) United States
(12) Patent Application Publication
(10) Pub. No.: US 2026/0285530 A1
(43) Pub. Date: Sep. 24, 2026

(54) Band Wrapping Device

(71) Applicant: Brady Worldwide, Inc., Milwaukee, WI (US)

(72) Inventors: Jack Prior, Weymouth (GB); Christian Tamblyn, Weymouth (GB)

(21) Appl. No.: 19/475,711

(22) PCT Filed: Apr. 24, 2023
(86) PCT No.: PCT/US2023/019636

§ 371 Date: Oct. 15, 2025

(51) Int. Cl. B65B 67/12; B41J 15/04; B65B 13/18

(52) U.S. Cl. CPC B65B 67/1277; B41J 15/044; B65B 13/186

(57) ABSTRACT

A band wrapping device forms a length of band material into a loop for automatically applying the band to a limb (e.g., wrist) of a user. The band wrapping device may receive the length of band material from a cassette receivable in the band wrapping device and can include a band transport mechanism for transporting the band material, a sealer module for sealing the band material to itself and cutting the band material to a length, and/or a ring module for reception of the limb of the user for band application. The device and its constituent components can help reduce the contact between the individual requiring a band and those applying the band, can help reduce waste by using a more precise amount of band material sized to the limb, and can help reduce the staffing requirements in areas in which the bands are to be applied.

### CROSS-REFERENCE TO RELATED APPLICATIONS

Not applicable.

### TECHNICAL FIELD

This disclosure relates to a band wrapping device that automatically applies a band onto the limb of a user or an object upon insertion of a limb of the user or the object into the band wrapping device.

### BACKGROUND

Looped bands are frequently attached to an individual and can be used to provide information about a wearer of the band to which the band is attached. As one non-limiting example, a band may be used at a hospital to provide unique patient or medical information that can be printed on the band or encoded on or in the band. As another non-limiting example, a band may be worn to indicate that the wearer has been permitted entry into an event or venue such as a concert, museum, amusement park, and so forth. As still yet another non-limiting example, a band may be provided and worn to indicate that the wearer is a visitor or permitted entry to a facility.

There are various ways in which information can be conveyed by a band including by the visual appearance of the band itself (for example, coloration or design), by printing of readable indicia on the band (such as text, images, barcodes, or other visual information), by constructing the band to support some variety of data interface whether passive or active (such as providing near-field communication, radio frequency identification tags, and so forth), and so forth. In some instances, the band itself may even be designed to operate on a principle of time expiration in which the appearance of the band changes some duration of time after activation to indicate that the band is no longer valid for use.

Most bands are designed to be attached around the limb of a user—most commonly around the wrist of a user—and affixed in such a way that band is not easily removed to ensure that the band is securely and uniquely applied to the wearer. While wristbands are perhaps the most common type of band, other types of bands do exist including ankle bands. For example, such ankle bands may be applied to infants in a neonatal intensive care unit (NICU).

Most commonly, a length of band material may be looped and fastened or secured around the wrist of a user as a wristband to secure the band to the wearer. Most bands are formed into loops in such a way that the band cannot be removed from the user without destroying the band closure mechanism or the band itself in some way. In such case, the loop of the wristband when the band is secured should be small enough around the wrist that the wristband cannot be slid over the hand so that the wristband is only removable in a destructible manner. However, the loop of the wristband must still be large enough that it does not constrict the wrist of the wearer, making the band uncomfortable to wear. Typically, a band is provided with some mechanism for closure of the loop such as a snap or region of the band with an adhesive that can be used to close the loop that requires manual operation during attachment of the band.

### SUMMARY

At present, most bands are manually applied. Depending on the use context, the band may be manually applied by the wearer or may be manually applied by another individual in a position of authority, such as a medical provider, an event host staffer, or so forth, to attach the band in a secure fashion. However, this manual application can be people and time intensive and may result in large amounts of waste.

If manual assistance is required in attaching the bands, this has traditionally required staff be present and in close contact with the individuals to whom the bands may need to be applied. For example, at a large concert venue it may be necessary to have tens or hundreds of staffers to attach band to tens of thousands of people over the span of a day. In a medical environment, the number of bands to be applied may be appreciably less on a volume basis; however, limiting contact may be highly desirable to avoid the possible transmission of contagious diseases in that context.

Likewise, most bands are provided in lengths selected to accommodate the largest possible application use. For example, most wristbands are provided at a predetermined length that is selected to be long enough to cover even the largest wrist dimensions. However, only a small number of individuals will have wrists of such large size, and in most wristband applications some amount of material will remain as a “tail.” That tail is often manually cut off and can constitute a rather sizable waste of band material across all wearers.

Still further, variance based on the human element can present the risk of inconsistent or improper band application. For example, if a particular wristband is attached too loosely, this may provide a situation in which the wristband could be removed and attached to another wearer, permitting possible misuse of the band.

Disclosed herein is a band wrapping device, sub-components of the band wrapping device, and a cassette mechanism for the band wrapping device. The device and related components may offer many benefits including, but not limited to, reducing the contact between those individuals requiring a band and those applying the band, reducing the amount of wasted band material by only using the precise amount of material required to apply the band regardless of the size of the object (for example, wrist) to which the band is applied, and to reduce the staffing levels in environments requiring banding.

According to one aspect, a cassette is disclosed for supplying a band to a band wrapping device. The cassette includes a cassette housing providing an interior volume and an exit and further includes a spool received in the interior volume of the cassette. The spool supports a length of band material that is wound onto the spool about a spool axis. The band material provides a pair of opposing of band surfaces that are heat sealable to one another (for example, one surface in the pair of opposing band surfaces may have a heatable adhesive coating thereon that melts upon heating). The length of band material extends from the spool to the exit of the cassette housing where the band material exits the cassette housing.

In some forms, the spool may include a hub and a flange. The hub may be centered on the spool axis and the flange may be arranged in a plane perpendicular to the spool axis. The length of band material may be wrapped around the hub about the spool axis and may spiral outwardly from the hub. The flange may maintain alignment of one of the edges of the length of band material by contact of that edge with a surface of the flange. The cassette housing may include a base wall comprising a post and the spool may be received on the post to rotate thereon.

In some forms, the cassette housing may be openable to provide access to the spool inside the cassette housing. The spool may be removable from the cassette housing to facilitate replacement of the band material.

In some forms, an axial end of the spool may extend through the cassette housing and may have teeth for engagement (which teeth may be situated outside the cassette housing). The engagement with the teeth on the axial end of the spool by, for example, teeth of a cooperating drive may facilitate driving a rotation of the spool about the spool axis.

In some forms, the cassette may further include a band clamp at the exit of the cassette housing. The band clamp may have a clamping surface that is biased into engagement with a clamping surface of the exit of the cassette housing to selectively capture a section of the length of band material between the clamping surface of the band clamp and the clamping surface of the exit of the cassette housing. The clamping surface of the band clamp may be biased toward the clamping surface of the exit so that, when the cassette is not inserted in the band wrapping device, the clamping surface of the band clamp engages and secures the section of the length of band material therebetween and to clamp the section of the band material in place relative to the exit. Then, when the cassette is inserted in the band wrapping device, the band clamp may be actuatable against a biasing force applied to the band clamp to separate the clamping surface of the band clamp and the clamping surface at the exit of the cassette housing to release the section of the band material, thereby permitting the band material to be moveable relative through the exit of the cassette housing.

In some forms, the cassette may further include an idler roller proximate the exit of the cassette configured to provide traction with a mating drive roller in the band wrapping device. The idler roller may be biased towards and into a path of the length of band material outside of the internal volume of the cassette housing.

In some forms, the cassette housing may include a top housing portion and a bottom housing portion. The top housing portion and the bottom housing portion may be separable from one another to provide access to the internal volume of the cassette housing and to provide access to the spool and the length of band material for replacement. The top housing portion and the bottom housing portion may be hinged together.

In some forms of the cassette, a cassette band material path may be defined between the spool and the exit of the cassette housing. A re-directional idler roller may be positioned along the cassette band material path in which the re-directional idler roller re-directs the path of the length of band material from a first direction to a different second direction. Between the re-directional idler roller and the exit, the length of band material may be twisted to re-orient the band material such that the pair of opposing of band surfaces are obliquely oriented with respect to the spool axis within the cassette housing.

In some forms, the cassette may further include a consumable protection mechanism. The consumable protection mechanism may include one or more of a contact chip or radio frequency identification device to identify the cassette as authentic.

In some forms, the cassette may be rewindable, with the spool being rotatable in either a clockwise or counterclockwise direction about the spool axis.

According to another aspect, a band transport mechanism is disclosed for a band wrapping device for controlling movement of a length of band material along a band transport mechanism path from a source of band material to a band application mechanism (such as a ring module and a sealer module). The band transport mechanism can also selectively provide tension to length of band material during a tensioning process for the band application mechanism. The band transport mechanism includes a feed mechanism, a band position roller and tensioner set, and a slack ballast pocket. The feed mechanism includes a pair of feed rollers driven by a feed mechanism stepper motor in which a portion of the band transport mechanism path extends between the pair of feed rollers. The band position roller and tensioner set is positioned between the feed mechanism and an exit of a band output channel at an end of the band transport mechanism path. The band position roller and tensioner set includes a band position roller driven by a band position roller stepper motor and further includes a tensioner mechanism. The tensioner mechanism includes a tension roller biased toward the band position roller under an applied tensioning force. The slack ballast pocket is positioned between the feed mechanism and the band position roller and tensioner set. The slack ballast pocket provides a section of the band transport mechanism path that is variable in length. The slack ballast pocket has a pair of opposing slack ballast pocket surfaces that define a longest path length for the band transport mechanism path in which a maximum slack is provided and a shortest path length for the band transport mechanism path in which no slack is provided. Under the applied tensioning force on the tension roller, a clamping force is applied between the band position roller and the tension roller such that, when the band position roller is driven, a rotation of the tension roller is effectuated upon transport of the band material until the clamping force is insufficient and the tension roller stops rotating, thereby causing the band position roller to slip with respect to the band material.

In some forms, the feed mechanism further may include a feed roller belt that links the feed mechanism stepper motor to at least one the pair of feed rollers to drive the rotation of the at least one of the pair of feed rollers.

In some forms, the feed mechanism further may include, apart from the pair of feed rollers, a cassette roller driven by the feed mechanism stepper motor. The cassette roller may be configured to oppose an idler roller provided on a structure of the cassette. The feed mechanism may further include a feed roller belt that links the feed mechanism stepper motor to at least one of the pair of feed rollers to drive the rotation of the pair of feed rollers and the feed mechanism may further include a cassette roller belt that links a rotation of the pair of feed rollers to a rotation of the cassette roller belt. The band transport mechanism may further include a photo-interrupter sensor positioned along the band transport mechanism path between the cassette roller and the pair of feed rollers that is configured to detect an edge of the length of band material.

In some forms, a spacing between the pair of opposing slack ballast pocket surfaces may positionally vary over a portion of a length the band transport mechanism path within the slack ballast pocket. The spacing between the pair of opposing slack ballast pocket surfaces may increase from the feed mechanism to a maximum spacing within the slack ballast pocket and then decreases from the maximum spacing to the band position roller and tensioner set.

In some forms, the band position roller may be driven by the band position roller stepper motor via a drive train of gears.

In some forms, the applied tensioning force between the tension roller and the band position roller may be adjustable. The tensioner mechanism may set the applied tensioning force between the tension roller and the band position roller by adjustment of a rotatable thumbwheel having an axial end of varying length that alters the tensioning applied by a biasing mechanism to the tension roller.

In some forms, a rotation or lack of rotation of the tension roller may be detectable and, when the band position roller is driven and the tension roller is detected as not rotating, the band transport mechanism halts the driving of the band position roller. The band position roller and tensioner set (and, particularly, a capacity of the tension roller to reflect a movement of lack thereof of the band material), in conjunction with the slack ballast pocket, can permit the band transport mechanism to account for an unknown amount of slack along the band transport mechanism path. In a slack removal operation, the pair of feed rollers may be held stationary and the band position roller may be driven to move the length of band material forward to cause the band material in the slack ballast pocket to follow the shortest path length within the slack ballast pocket, until all slack is removed and a lack of movement of the tension roller is detected which thereby results in halting driving of the band position roller. In a band application operation, the pair of feed rollers may initially advance the length of band material into the slack ballast pocket to create a pre-established amount of slack. Then, in the band application operation, after the pre-established amount of slack has been established in the slack ballast pocket, the tension roller and the pair of feed rollers may drive the length of band material in a reverse direction to create a tension in the band material and, upon exceeding the clamping force of the tension roller and the tension roller stops rotating and, subsequently, the tension roller and the pair of feed rollers are halted, any delay between a detection that the tension roller has stopped rotating and the halting of the pair of feed rollers is accounted for by only a partial consumption of the slack in the slack ballast pocket.

In some forms, the band position roller and tensioner set may further include a magnetic encoder wheel rotatably connected with the tension roller and may further include a Hall effect sensor capable of detecting travel of the band material via a monitoring of the rotation of the magnetic encoder wheel on the tension roller.

According to another aspect, a sealer module is disclosed for a band wrapping device. The sealer module includes a location block assembly translatable by an actuation mechanism to move an engagement end of the sealer module from a retracted position to a band closure position for sealing a band material to itself to form a loop. The location block assembly carries a plurality of components that are movable with the location block assembly and therefore actuatable by the actuation mechanism. The plurality of components includes a primary clamp having a primary clamp surface and a heater element having a heatable face, and optionally a cutter mechanism including a blade assembly. In the retracted position, the primary clamp surface is positioned at and biased towards a leading-most end of the engagement end of the sealer module to provide that the primary clamp surface first contacts the band upon actuation of the location block assembly towards the band closure position. The primary clamp surface is deflectable from the leading-most end of the engagement end under an applied pressure. The heatable face is heatable and displaceable to contact the band material in an area of overlap to effectuate sealing of the band material to itself by applying heat and pressure on the band material (which may, for example, be used to melt an adhesive). The heatable face is biased towards a leading-most end of the engagement end of the sealer module. In the retracted position, the heatable face is positioned behind the primary clamp surface along a direction of translation of the location block assembly relative to the engagement end.

In some forms, the actuation mechanism may include a cam mechanism in which a cam is rotatable about an eccentric cam axis. The cam may have a cam engagement surface positioned to engage a location block cam engagement surface of the location block assembly to effectuates the translation of the location block assembly as the cam is rotated about the eccentric cam axis.

In some forms, the sealer module may further include an anvil in which the anvil is positionable in opposition to the primary clamp surface of the primary clamp and the heatable face of the heating element. In such position of the anvil, when the sealer module is moved from the retracted position to the band closure position, the primary clamp surface and the heatable face are drawn toward engagement with the anvil. The anvil itself may be movable between an anvil sealing position and an anvil retracted position. In the anvil sealing position, the anvil may be positioned in opposition the primary clamp surface of the primary clamp and the heatable face of the heating element such that, when the sealer module is moved from the retracted position to the band closure position, the primary clamp surface and the heatable face are drawn toward engagement with the anvil and, in the anvil retracted position, the anvil may be withdrawn to permit a removal of the band material or a band formed therefrom.

In some forms, a resistive heating element may be positioned at the heatable face. The resistive heating element may be a nickel-chromium alloy material and, more particularly, 80 percent by weight nickel and 20 by weight chromium. The resistive heating element may have a pair of terminals for electrical connection which are spot welded to copper on one face of a respective terminal and steel on an opposing face of the respective terminal. The heatable face may include a heater platform over which the resistive heating element is located and adhered and may further include a heatable face cover that is applied over the resistive heating element. The heater platform may be a polyetheretherketone (PEEK) material and the heatable face cover may be a polytetrafluoroethylene (PTFE) material. It is contemplated that, in some forms, rather than a resistive heating element being present at the heatable face, ultrasonic bonding could be used to join the band material to itself. In that case and for example, a sonotrode could be used at the face of the heater element to generates friction and heat at the heatable face. With such ultrasonic bonding, the anvil could still be used in opposition to the ultrasonic bonding element of the heater element, with the overlapping band material positioned therebetween.

In some forms, upon movement of the engagement end of the sealer module from the retracted position to the band closure position by the actuation mechanism, the following sequence may occur in order. First, the primary band clamp surface can contact the band material in a region of overlap of the band material to hold the band material in place and establish a closed loop. The heatable face of the heat element can then contact the band material (although not be heated at this time). If there is a blade assembly present, the blade assembly can contact the band material to cut the band material to separate the closed loop from a remainder of the band material. Finally, the heater element can be heated to seal the band material to itself to securely form the band material into the closed loop.

In some forms, the sealer module of claim may further include a secondary clamp having a secondary clamp surface. The blade assembly (if present as part of the sealer module) can be positioned between the secondary clamp surface and the heater element, and the secondary clamp is configured to hold the band material in place while the blade assembly performs a cutting operation.

According to another aspect, a ring module is disclosed for a band wrapping device in which a length of a band material is presented around, tensioned, and formed into a loop around an object (for example, the wrist of a user) received within a center opening of the ring module. The ring module includes a first ring, a second ring, and a rotatable control ring. The first ring has a first ring edge partially defining a channel for a band material ring path through the ring module. The second ring has a second ring edge opposing the first ring edge and the second ring edge also partially defines the channel for the band material ring path through the ring module. The second ring is movable with respect to the first ring to alter an axial spacing of the first ring edge and the second ring edge thereby altering a width of the channel of the band material ring path. The rotatable control ring is rotatable and in engagement with the second ring to move the second ring relative to the first ring.

In some forms, the rotatable control ring and/or the second ring may have a plurality of ramped projections thereon for engaging the other of the rotatable control ring and the second ring upon a rotation of the rotatable control ring relative to the second ring. When the rotatable control ring is rotated with respect to the second ring and engaged therewith, the axial spacing of the first ring edge and the second ring edge is changed by an angular positioning of the plurality of ramped projections to alter the width of the channel. The plurality of ramped projections on the rotatable control ring and/or the second ring can be located on an axial face thereof. In some forms, the first ring may have a plurality of corresponding slots aligned with the plurality of ramped projections and the plurality of ramped projections extend through the plurality of corresponding slots (for example, the ramped projections on the rotatable control ring can extend through the slots on the first ring such that the ramped portions of the projections engage features on the second ring that facilitate axial displacement upon rotation of the rotatable control ring).

In some forms, the second ring may be biased by one or more ring biasing elements toward the first ring in an axial direction. The rotatable control ring may have a closed path rotational position that allows the first ring and the second ring to be biased together by this biasing force (effectively not pushing back against it) and may also have an open path rotational position that pushes the second ring against the ring biasing elements to separate the first and the second ring in the axial direction.

In some form, the first ring edge and the second ring edge may provide undercuts. The undercuts may prevent the band material from radially exiting the channel for the band material ring path in at least some closer axial spacings of the first ring edge and the second ring edge based on the width of the band material. However, upon further axially spacing the first ring edge and the second ring edge, the band material may be allowed to radially exit the channel for the band material ring path to permit tensioning of the band material.

In some forms, the first ring may be fixed in place relative to the band wrapping device of which the ring module is a part.

In some forms, the rotatable control ring may be moved by a motor and gear set in which the rotatable control ring has gear teeth which are driven by a gear that is driven by a motor to effectuate rotation of the rotatable control ring relative to the first ring.

In some forms, the ring module may further include a linkage arm that links the rotatable control ring to a wristband clamp. The rotatable control ring may move the wristband clamp between a pinch position for holding a leading end of the band material during tensioning and a release position in which the band material is released. When the rotatable control ring is moved to a position in which the axial spacing between the first ring edge and the second ring edge is widened so the band material can exit the channel for a tensioning operation, the wristband clamp may be actuated to the pinch position.

In some forms, the ring module may further include a gravity bias flag and sensor set positioned within the channel of the band material ring path. The gravity bias flag and sensor set may detect the presence of the band material within the channel of the band material ring path.

In some forms, the ring module may further include one or more indicators attached to a housing of the ring module. The one or more indicators may provide prompts for a user operation of the ring module. For example, the one or more indicators may include an LED animation, pattern, or color that provide the prompts for the user operation of the ring module.

In some forms, the ring module may further include a time-of-flight sensor for detecting a presence of the object within the center opening of the ring module. Upon detecting the object within the center opening of the ring module, an LED light at the top of the ring module may project a light silhouette of a wristband onto the object indicating where the band will be applied on the object. The ring module may further include one or more capacitive touch pads. The ring module may be configured to perform a tensioning operation only when capacitive touch pads are contacted by the object and when the time-of-flight sensor also detects the object within the center opening of the ring module. This can prevent misuse of the ring module and ensure appropriate attachment of the band material.

In some forms, the ring module may further include an anvil that is movable between an anvil sealing position and an anvil retracted position. During a tensioning and sealing operation of the band material by the ring module, the anvil may be positioned in the anvil sealing position. After the tensioning and sealing operation of the band material is complete, the anvil may be movable to the anvil retracted position to permit the band material formed into the loop to be removed from the ring module (and the object/wrist to which the looped band material has been attached).

According to still yet another aspect, a band wrapping device for forming a length of band material into a loop is disclosed. The band wrapping device includes a band transport mechanism, a ring module, and a sealer module. The band transport mechanism has a band transport mechanism path running therethrough. Along the band transport mechanism path, a plurality of rollers is positioned to advance or reverse the length of a band material through the band transport mechanism path. The ring module receives the length of band material from the band transport mechanism. The ring module forms the length of band material into the loop around an object (such as a wrist) received within a center opening of the ring module. The sealer module clamps and seals the length of band material to close the loop (and, in some forms, can also cut it to separate the loop from a remainder of the length of band material).

In some forms, the band transport mechanism path may run from a cassette tray for receiving a cassette (which cassette provides the length of band material) to the ring module.

In some forms, the band transport mechanism may include a feed mechanism, a band position roller and tensioner set, and a slack ballast pocket. The feed mechanism may include a pair of feed rollers driven by a feed mechanism stepper motor in which a portion of the band transport mechanism path extends between the pair of feed rollers. The band position roller and tensioner set may be positioned between the feed mechanism and an exit of a band output channel at an end of the band transport mechanism path. The band position roller and tensioner set may include a band position roller driven by a band position roller stepper motor and may further include a tensioner mechanism including a tension roller biased toward the band position roller under an applied tensioning force. The slack ballast pocket may be between the feed mechanism and the band position roller and tensioner set. The slack ballast pocket may provide a section of the band transport mechanism path that is variable in length. The slack ballast pocket may have a pair of opposing slack ballast pocket surfaces that define a longest path length for the band transport mechanism path in which a maximum slack is provided and a shortest path length for the band transport mechanism path in which no slack is provided. Under the applied tensioning force on the tension roller, a clamping force may be applied between the band position roller and the tension roller that, when the band position roller is driven, effectuates a rotation of the tension roller upon transport of the band material until the clamping force is insufficient and the tension roller stops rotating, thereby causing the band position roller to slip with respect to the band material.

In some forms, the sealer module may include a location block assembly translatable to move an engagement end of the sealer module from a retracted position to a band closure position by an actuation mechanism. The location block assembly may carry a plurality of components that are movable with the location block assembly and actuatable by the actuation mechanism. The plurality of components may include a primary clamp having a primary clamp surface, a heater element having a heatable face, and an optional cutter mechanism including a blade assembly. In the retracted position, the primary clamp surface may be positioned at and biased towards a leading-most end of the engagement end of the sealer module to provide that the primary clamp surface first contacts the band upon actuation of the location block assembly towards the band closure position and is deflectable from the leading-most end of the engagement end under an applied pressure. The heatable face may be heatable and displaceable to contact the band material to effectuate sealing of the band material to itself by heating the band material and applying a pressure. The heatable face may be biased towards a leading-most end of the engagement end of the sealer module. In the retracted position, the heatable face may be positioned behind the primary clamp surface along a direction of translation of the location block assembly relative to the engagement end.

In some forms, the ring module may include a first ring and a second ring. The first ring may have a first ring edge partially defining a channel for a band material ring path through the ring module. The second ring may have a second ring edge opposing the first ring edge. The second ring edge may partially define the channel for the band material ring path through the ring module. The second ring may be movable with respect to the first ring to alter an axial spacing of the first ring edge and the second ring edge thereby altering a width of the channel of the band material ring path.

While various features have been described above, it will be readily apparent and understood that these features can be used in any workable combination or permutation with one another or independently of one another and such workable variations fall within the scope of this disclosure

These and still other advantages of the invention will be apparent from the detailed description and drawings. What follows is merely a description of some preferred embodiments of the present invention. To assess the full scope of the invention the claims should be looked to as these preferred embodiments are not intended to be the only embodiments within the scope of the claims.

### BRIEF DESCRIPTION OF THE DRAWINGS

FIG. 1 is a front, right, top perspective view of a band wrapping device.

FIG. 2 is a rear, right, top perspective view of the band wrapping device of FIG. 1.

FIG. 3 is a front, right, top perspective view of the band wrapping device from FIG. 1, in which a front door of the band wrapping device has been swung downwards to the open position and the cassette has been partially pulled forward out of the band wrapping device.

FIG. 4 is a front, left, top perspective view of the cassette apart from the band wrapping device.

FIG. 5 is a front, left, top perspective view of the cassette of FIG. 4 in which the lid has been swung open to reveal the inside of the cassette including the spool supporting a length of band material and the band material path from the spool to the exit of the cassette which includes a band clamp and an idler roller.

FIG. 6 is a front, left, top perspective view of the cassette of FIG. 5 in which the spool is illustrated as being removed from the post with no band material being disposed on the spool.

FIG. 7 is a rear, left, top exploded perspective view of the exit of the cassette with the spring plate, idler roller, and band clap exploded from the bottom of the cassette housing.

FIG. 8 is a rear, left, top perspective view of the exit of the cassette with the spring plate, idler roller, and band clap assembled to the cassette housing.

FIGS. 9A and 9B are cross-sectional views of the cassette housing taken through the exit illustrating the band clamp in clamping and release positions respectively.

FIG. 10 is a view of a cassette receptacle in isolation from the rest of the band wrapping device to clearly illustrate a motor on a top side thereof that drives a toothed driver (shown in dashed lines) for engaging the top axial end of the spool for controlling the rotation of the spool within the cassette.

FIG. 11 is a perspective view of the band wrapping device illustrating the placement of a band transport mechanism therein in dashed lines.

FIG. 12 is a front, left side perspective view of the band transport mechanism apart from the rest of the band wrapping device.

FIG. 13 is a rear, right side perspective view of the band transport mechanism apart from the rest of the band wrapping device.

FIG. 14 is a front, left side partial cross-sectional perspective view with one half of the housing removed to illustrate the band path through the band transport mechanism showing a feed mechanism, a band position roller and tensioner set, and a slack ballast pocket.

FIG. 15 is a rear, right side perspective view with the rear housing plate removed illustrating some of the drive trains of the feed mechanism and the band position roller and tensioner set within the housing of the band transport mechanism.

FIG. 16 is a rear, right side perspective view of the feed mechanism including a motor, a pair of feed rollers, and a cassette roller.

FIG. 17 a front, left side partial cross-sectional perspective view with one half of the housing removed as well as the feed mechanism and the band position roller and tensioner set removed to illustrate just the band transport mechanism path and the slack ballast pocket.

FIG. 18 is a front, left side perspective view of the band position roller and tensioner set.

FIG. 19 is a rear, right side perspective view of the tensioner mechanism of the band position roller and tensioner set.

FIG. 20 is cross sectional view taken through the tensioner set illustrating the biasing mechanism providing variable biasing force.

FIGS. 21A-D illustrate a sequence of band material feeding steps (showing arrows indicating roller rotation). In FIG. 21A, the band material is initially pulled from the cassette through the feed roller which all driven rollers advance the material forward. In FIG. 21B, the band material is advanced by the band and tensioner set to remove all slack in the slack ballast pocket to establish a known amount of slack before the band is further advanced in the ring module to form a loop. In FIG. 21C, the band wrapping device generates a controlled amount of slack in the slack ballast pocket by advancing only the pair of feed rollers while the remainder of the mechanism remains stationary. In FIG. 21D, the rollers are rotated in reverse to tension the band material until the tension roller stops rotating and, due to a brief delay in detection and stopping the rotation of the rollers, some portion of the slack in the slack ballast pocket is consumed.

FIG. 22 is a perspective view of the band wrapping device illustrating the placement of a sealer module therein in dashed lines.

FIG. 23 is a top, front, left perspective view of the sealer module with the surrounding housing removed.

FIG. 24 is an exploded view of the assembly of FIG. 23 showing a location block, heater element, primary and secondary clamps, and cutter mechanism apart from one another.

FIG. 25 is a perspective view of the nickel-chromium resistive heating element.

FIG. 26 is a side schematic showing the spot-welding technique at the termination of the resistive heating element.

FIG. 27A-G are side views of the sealer module being used to seal (and, in some forms, cut) a length of band material shown in an exemplary sequence. FIG. 27A shows the sealer module in a retracted position while the material of the band is being positioned in the ring module. FIG. 27B shows the sealer module initially advanced until the primary clamp has clamped a section of the overlapped material against the anvil, but before the cutting has occurred. FIGS. 27C and 27D shows the further advancement of the sealer module with the unpowered heating element contacting the overlapped band material to fold the material around the cutter block and the blade being positioned to initiate a cut. FIGS. 27E and 27F show the secondary clamp contacting the band material as the cut is executed and the band material is heated to be sealed. FIG. 27G shows the location block assembly being retracted after the loop is formed and severed from the remainder of the band material.

FIG. 28 is a top, front, right side perspective view of the band wrapping device illustrating the placement of a ring module therein in dashed lines.

FIG. 29 is a top front, right side view of the ring module apart from the band wrapping device.

FIG. 30 is a top, front, right side view of the ring module of FIG. 29 in which part of ring cover and some of the housing has been removed to reveal the rotatable control ring and the drive.

FIG. 31 is top, rear, right side view of the ring module of FIG. 29 showing the anvil on the rear side.

FIG. 32 is an exploded view of the rotatable control ring, the first ring, and the second ring apart from the ring module to reveal the projections on the control ring, the features that those projections interact with in the second ring, and the slots on intermediate first ring through which the projections extend.

FIG. 33 is a top-down cross-sectional view taken through the ring module illustrating the channel for the band with the channel closed.

FIG. 34 is a top-down cross-sectional view taken through the ring module illustrating the channel for the band with the channel expanded.

FIG. 35 is perspective view showing the rotatable control ring with a linkage arm and a wristband clamp that are movable with the rotatable control ring, in which the wristband clamp is actuatable and used to selectively pinch the band material during a tensioning, sealing, and cutting operation on the band material.

FIG. 36 is a top, rear, right side view of the ring module stripped down to better show the anvil in an extended position.

FIG. 37 is a top, rear, right side view of the ring module stripped down to better show the anvil in a retracted position.

FIG. 38 is a top, rear, right side view of the anvil assembly apart from the ring module in the retracted position.

### DETAILED DESCRIPTION

Unless otherwise defined, the technical terms or scientific terms as used in the claims and the description should be construed in a generic meaning as understood by those of ordinary skill in the art to which the present invention pertains. The terms “first”, “second”, or the like as used in the description and claims of the patent application do not denote any order, quantity, or importance, but are merely used to distinguish different components. The terms “a”, “an” or “the” like do not denote a quantity limitation but mean that there is at least one. The terms “include”, “comprise” or the like mean that the elements or objects that precede “include” or “comprise” encompass the elements or objects and their equivalents that appear after “include” or “comprise” and do not exclude other elements or objects. The terms “connect”, “connected” or the like are not limited to physical or mechanical connections, nor are they limited to direct or indirect connections.

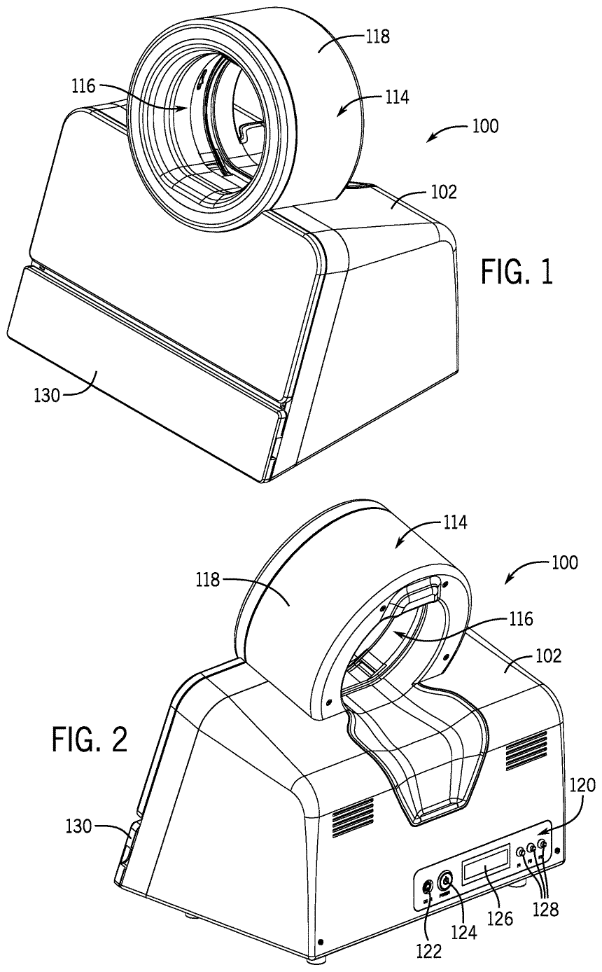

The terms “top”, “bottom”, “front”, “rear”, “left”, “right”, and so forth used herein are exemplary directions defined only for facilitating the description. For example, as shown in FIG. 1, the directions toward the reader are front, left, and top (given the perspective view) and the directions away from the reader is rear, right, and bottom. Of course, those skilled in the art would be able to understand that the directions such as “top”, “bottom”, “front”, “rear”, “left”, and “right” can be defined in other ways, which also fall within the scope of protection of the present disclosure.

A structure having an “integral design” is a component formed from one piece of material, such as a molded piece. A structure having a “composite design” is a component formed from more than one distinct piece (or part), which upon assembly are combined.

Referring first to FIGS. 1 and 2, a band wrapping device 100 is illustrated for the application of a wristband onto an individual's wrist. While in the description that follows, the band wrapping device 100 may be described as applying a wristband to a wrist of a user, the band wrapping device 100 may be used more generally to apply a band to any limb. For example, and without limitation, the band wrapping device 100 may be suitable or adapted to attach an ankle band to the ankle or leg of a user.

From the outside, the band wrapping device 100 includes a main body 102, which will house various operational components that will be described in greater detail below with respect to various other figures including a cassette 104 received in a cassette tray 106 that provides a length of band material 108; a band transport mechanism 110 for controlling movement of the length of band material along a band transport mechanism path from a source of band material (such as, for example, the cassette 104) to a band application mechanism, a sealer module 112 for sealing (and, in some embodiments, cutting) the length of band material 108 once a loop is formed from it; and a portion of a ring module 114 in which the length of band material 108 is presented around, tensioned, and formed into a loop around an object or limb received within a center opening 116 of the ring module 114. In the exemplary embodiment illustrated, the above-described components are internally located with respect to the main body 102 except for the ring module 114, which has a ring 118 which is situated at the top end of the main body 102. The main body 102 includes a user panel 120 on a rear side thereof, best seen in FIG. 2, which may include a connector 122 for attachment of the band wrapping device 100 to a source of power or plug, a power button 124, a display 126, and other control buttons 128. These, as well as other operational controls which may be part of the band wrapping device 100 or apart therefrom, may be used to control operation of the band wrapping device 100. For example, in some embodiments, some or all the operational controls could be differently placed on the band wrapping device 100 in one or more locations and/or apart from the band wrapping device 100 such as part of a computer application or program that runs on a separate computer or mobile device with communicative connectivity to the band wrapping device 100.

In general operation of the band wrapping device 100, an individual may place a wrist into the central opening 116 of the ring 118. With the wrist appropriately situated in the central opening 116 of the ring 118, a portion of the length of band material 108 may be looped and appropriately sized around the wrist of the user. At a point of overlap of the band material, the looped band can then be sealed to itself from the rest of the length of band material 108 using the sealer mechanism 112. The sealer module 112 may be outfitted with a cutting mechanism to sever the looped band from the rest of the band material 108 or there could be another cutting mechanism. The wrist, with the band applied thereto, can then be removed from the band wrapping device 100. The remaining length of band material 108 can then be advanced to a position in which the process can be repeated, another loop can be formed around the wrist of another individual, and so forth. In this way, the band wrapping device 100 can provide a device for high-throughput and reproduceable band application that is automated and does not require the direct application of a band by either the individual receiving the band on the wrist or an authorized individual/staff (for example, an administrator, nurse, event staff, and so forth). Rather, any authorized individual/staff that would normally be involved in band application can supervise the use of the band wrapping device 100 or a group of such band wrapping devices, greatly improving efficiency and consistency of band application at an application location such as a point of entry.

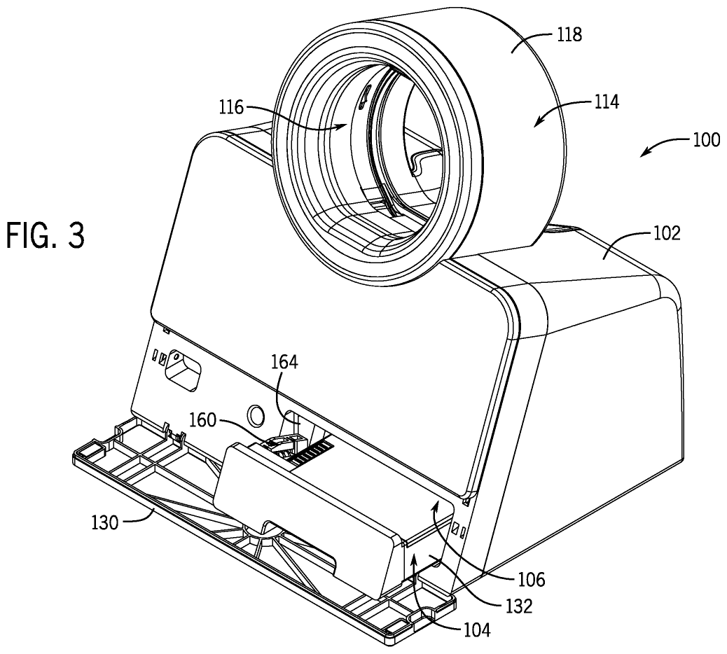

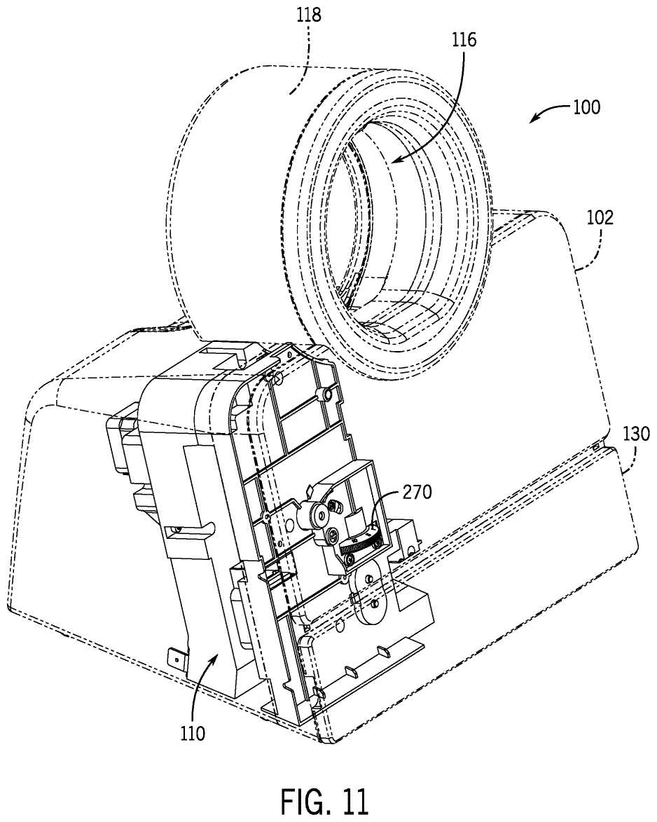

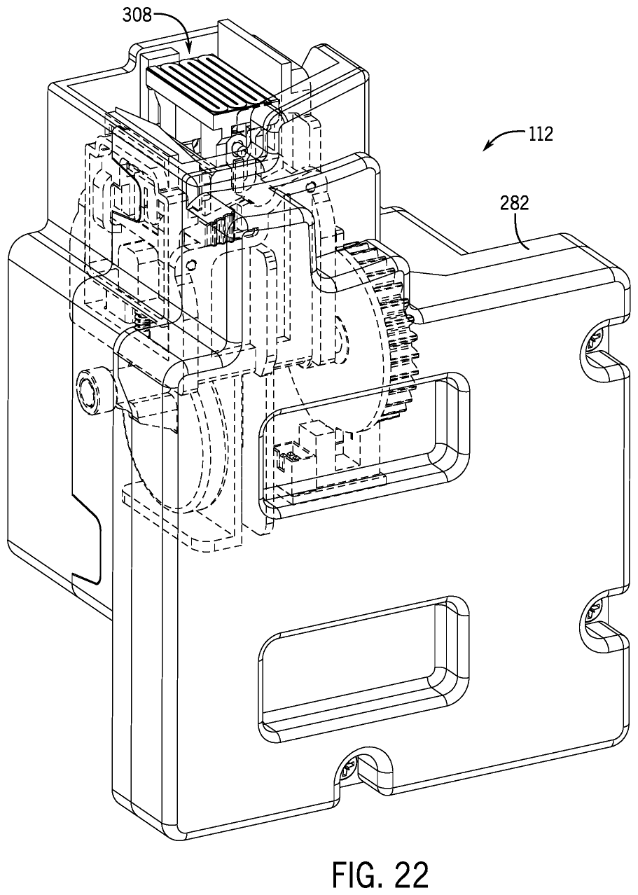

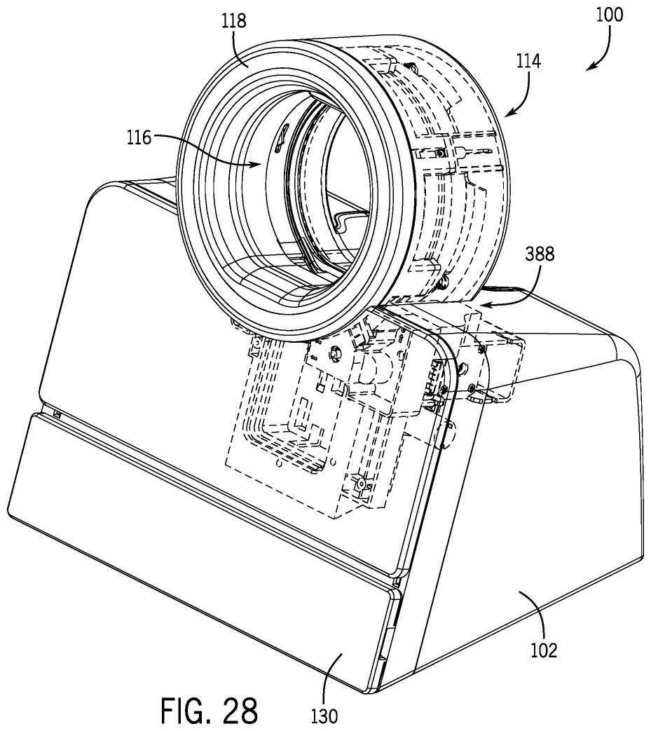

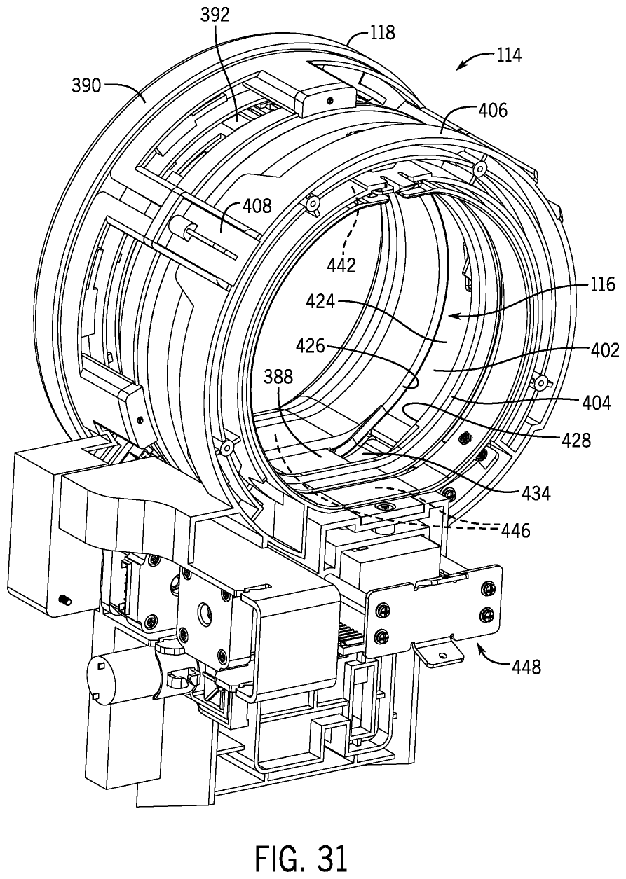

In the subsections of the detailed description that follow, four sub-sections or aspects of the band wrapping device 100 will be described separately and then a more complete description of the overall operation of the device will be provided explaining the interaction of these components with one another. These sub-sections or aspects include the cassette 104 (FIGS. 3 through 10), the band transport mechanism 110 (FIGS. 11 through 21), the sealer mechanism (FIGS. 22 through 26), and the ring module (FIGS. 28 through 37).

### The Cassette

Turning now to FIGS. 3 through 10, a first aspect of the band wrapping device 100 will be described in more detail, the exemplary cassette 104 that carries and provides the length of band material 108 to be used by the band wrapping device 100. The cassette 104 can be a consumable item that is entirely replaced once the length of band material 108 is consumed or may be reloaded with an additional length of band material and the cassette reused.

As illustrated in FIG. 3, a cassette tray access door 130 is disposed on a lower end of the front side of the main body 102 of the band wrapping device 100. This cassette tray access door 130 may be opened as depicted in FIG. 3 to provide access to the cassette tray 106. In FIG. 3, the cassette 104 is illustrated as being partially inserted into or withdrawn from the cassette tray 106. With the cassette tray access door 30 open, the cassette 104 is linearly translatable into and out of the cassette tray 106.

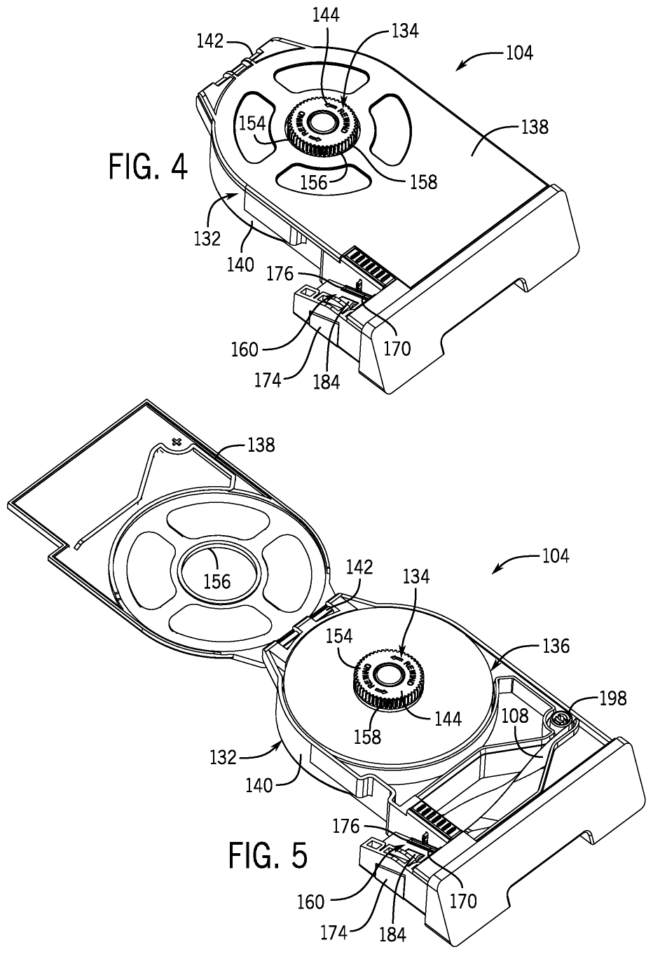

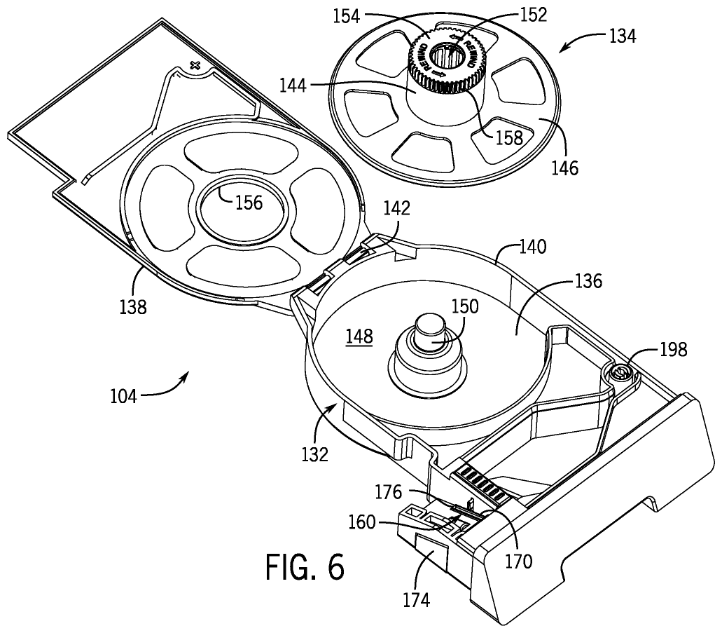

Turning now to FIGS. 4 and 5, the cassette 104 is shown apart from the band wrapping device 100 in a closed and opened configuration of the cassette 104, respectively. The cassette 104 includes a cassette housing 132 and a spool 134 supported by the cassette housing 132. The spool 134 is receivable inside the interior volume 136 of the cassette housing 132 (as depicted best in FIG. 5) and this spool 134 supports the length of band material 108 that is wound onto the spool 134 about a spool axis. As best illustrated in FIG. 6, the spool 134 can be a separate component and separable from the cassette housing 132 to potentially permit replacement of the length of band material 108 supported by the spool 134 or the spool itself. In this way, the cassette 104 can be designed to stay with the band wrapping device 100 with only the spool 134 or length of band material 108 being replaced such that most of the materials of the cassette 104 can be reused, except for the consumable parts.

Looking more closely at the cassette housing 132 in the form illustrated, the cassette housing 132 includes a top housing portion 138 and a bottom housing portion 140. To provide access to the interior volume 136 of the cassette housing 132 for accessing the spool 134 and/or the length of band material 108 thereon, the top housing portion 138 and the bottom housing portion 140 can be separable from one another. This separability in the cassette 104 as shown involves connecting the top housing portion 138 and the bottom housing portion 140 by a hinge 142 that is integrally formed into the top housing portion 138 and the bottom housing portion 140 in which the parts of the hinge 142 snap together. However, the separability of the housing components could be differently achieved, such as for example without limitations, by snapping the components of the cassette housing together or apart in a non-hinged manner to provide access to the internal volume or the spool. Still further, in some forms of the cassette, it is contemplated that cassette housing could be permanently secured in a closed position and, even if there are multiple cassette housing components, that these components may not be separable, such that the cassette is effectively a disposable item.

With reference being had to FIG. 6 and looking more closely at the structure of the spool 134, the spool 134 has a hub 144 and a flange 146. As illustrated, the hub 144 is centered on the spool axis and the flange 146 is arranged in a plane perpendicular to the spool axis. Although one large flange is illustrated, it is contemplated that in other forms there could be multiple flanges or fins that provide a support plane for the band material 108, or that no flange may be present and the walls of the cassette housing may assist with constraining and positioning the band material. As shown in FIG. 5, the length of band material 108 is wrapped around the hub 144 and spirals outwardly from the hub 144, generally in a clockwise direction relative to the orientation of FIG. 5 on the page. The flange 146 maintains alignment of one of the edges of the length of band material 108 by contacting that edge with a surface of the flange 146 (that is, the lower edge of the band material 108 as considered relative to the orientation of the cassette 104 on the page in FIG. 6).

To facilitate the positioning and placement of the spool 134 relative to the cassette housing 132, the cassette housing 132 can include a base wall 148 with a post 150 extending upwardly therefrom as depicted best in FIG. 6. This post 150 can provide a bearing surface or shaft upon which a centrally located hole 152 on the spool 134 can be placed or seated and, more specifically, position the hub 144 of the spool 134 along the spool axis which is then coincident with the central axis of the post 150. When the spool 134 is received on the post 150 as depicted in FIG. 5, the spool 134 can therefore rotate on the post 150. However, the spool 134 can also be axially separable from the post 150 as depicted in FIG. 6 to remove the spool 134 therefrom such that the spool 134 could be removed to replace or refill the band material 108 either with the same spool after reloading or potential with another pre-wound spool. It is contemplated that, in some forms, the post 150 might be eliminated and the interaction of the outer edge of the flange 146 of the spool 134 within the inner walls or periphery of the cassette housing 132 could sufficiently position the spool 134 within the cassette housing 132.

Additionally, as can be seen in FIGS. 4 through 6, an axial end 154 of the spool 134 can extend or project through the cassette housing 132 (more specifically the top housing portion 138 of the cassette housing 132). In the embodiment illustrated, the top housing portion 138 has a spool opening 156 that aligns with the axial end 154 of the spool 134 when the top housing portion 138 is closed with respect to the bottom cover portion 140 as depicted in FIG. 4. The axial end 154 of the spool 134 then projects through this spool opening 156 and has teeth 158 on the axial end 154 of the spool 134 that are accessible from the exterior of the cassette 104.

The band material 108 could have different structural forms, but for the band wrapping device 100 illustrated in which the band material 108 will eventually be heated and sealed to itself to form a band loop, the band material 108 has a pair of opposing of band surfaces in which one surface in the pair of opposing band surfaces has an adhesive coating thereon that is heat responsive, such as a hot melt adhesive. In some forms however, it is contemplated that the adhesive coating could be a pressure sensitive adhesive. In any event, the band material 108, upon heating, should be joinable to itself whether with or without adhesive being present. The length of band material 108 extends along a cassette band material path from the spool 134 to an exit 160 of the cassette housing 132 at which location the band material 108 exits the cassette housing 132 and is fed into the band transport mechanism 110 of the band wrapping device 100.

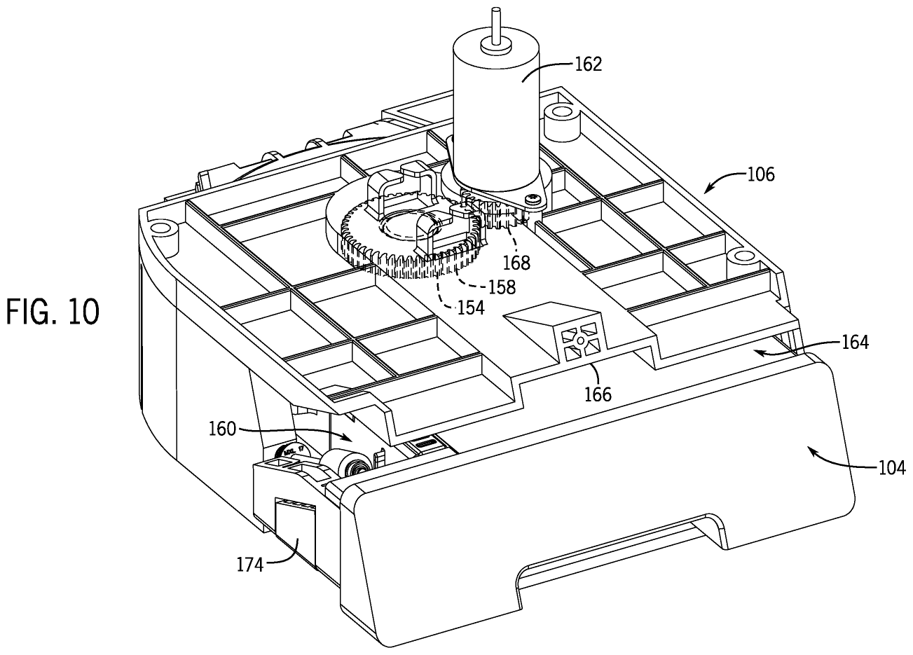

With forward reference being made to FIG. 10, the cassette tray 106 and a spool drive motor 162 are shown apart from the band wrapping device 100 with the cassette 104 inserted into a reception slot 164 of the cassette tray 106. In the exemplary form depicted, the reception slot 164 for receiving the cassette 104 has a gear channel 166 extending along the direction of cassette insertion into the reception slot 164 which specifically receives the axial end 154 of the spool 134. The spool drive motor 162 can be a conventional brushed DC motor.

The spool drive motor 162 is arranged on and mounted to a top side of the cassette tray 106. The spool drive motor 162 is connected to and drives a spool drive gear 168, which is shown in dashed lines at the bottom end of the spool drive motor 162. The upper side of the cassette tray 106 can provide an opening or clearance such that the spool drive gear 168 of the spool drive motor 162 is positioned adjacent to the gear channel 166 of the reception slot 164 for engagement of the spool drive gear 168 with the teeth 158 on the axial end 154 of the spool 134 of the cassette 104 when the cassette 104 is fully inserted into the cassette tray 106. Essentially, upon insertion, the teeth 158 on the axial end 154 of the spool 134 are slid into engagement with the teeth of the spool drive gear 168 of the spool drive motor 162 and, upon removal of the cassette 104 from the cassette tray 106, the teeth are slid out of engagement with one another. In this way, the spool 134 of the cassette 104 can be driven or controlled by the spool drive gear 168 of the spool drive motor 162 during operation of the band wrapping device 100. During use, the spool drive motor 162 can control the rewinding of the spool 134 during both the use of the band wrapping device 100 and during ejection of the cassette 104 from the cassette tray 106. Thus, the cassette 104 is rewindable with the spool 134 being rotatable in either a clockwise or counterclockwise direction about the spool axis.

With reference to FIGS. 4 through 6 generally, the cassette housing 132 also provides the exit 160 of the cassette 104, which is now described in more specific detail given how it controls the passage of the band material 108 and interacts with surrounding structure of the band wrapping device 100. From the exit 160, the length of band material 108 can leave the cassette 104 and enter the band transport mechanism 110 of the band wrapping device 100 as will be described in greater detail below in the respective section addressing the band transport mechanism 110.

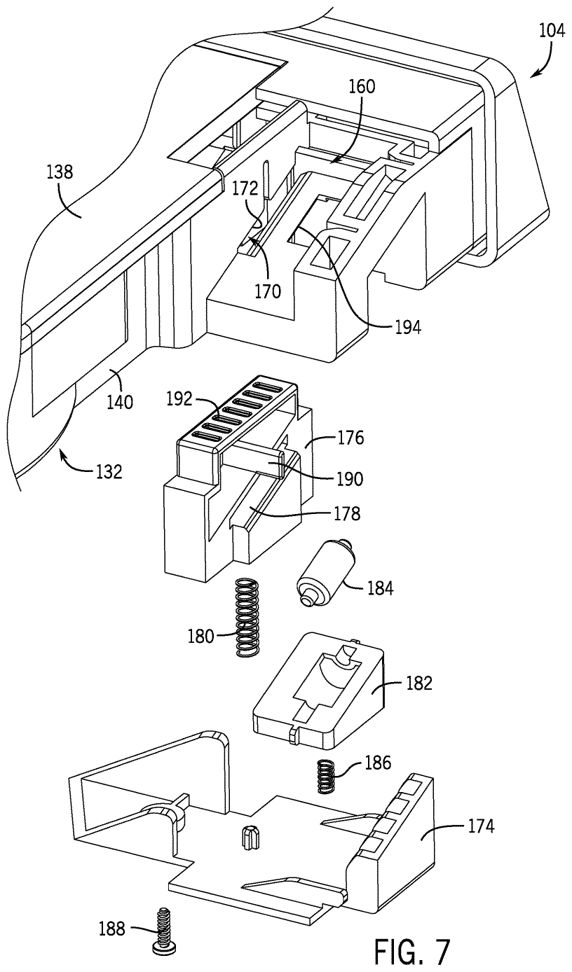

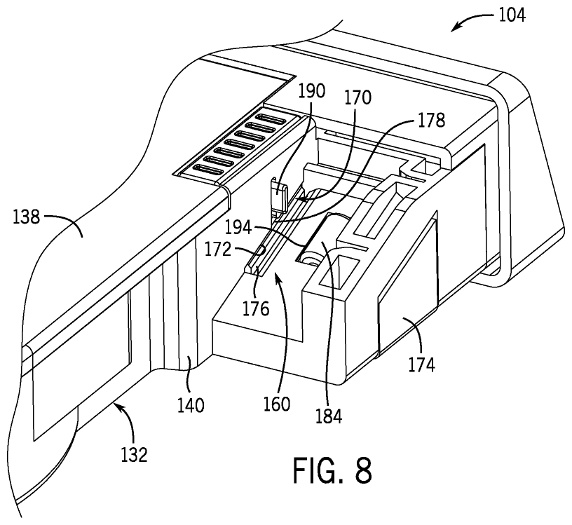

FIGS. 7, 8, 9A, and 9B show the exit 160 of the cassette 104 in greater detail as well as the operative components thereof. FIG. 7 provides an exploded view of the various components in the region of the exit 160 and FIG. 8 shows those components in assembled form. The components defining the exit 160 include the aforementioned bottom housing portion 140 providing a band material passage 170 with a band material passage clamping surface 172, a removable plate 174 for securing some of the components relative to bottom housing portion 140 of the exit 160, a band clamp 176 providing a band clamp clamping surface 178, a band clamp biasing element 180 (in the form of a spring), an idler roller holder 182, an idler roller 184, and an idler roller biasing element 186 (in the form of a spring).

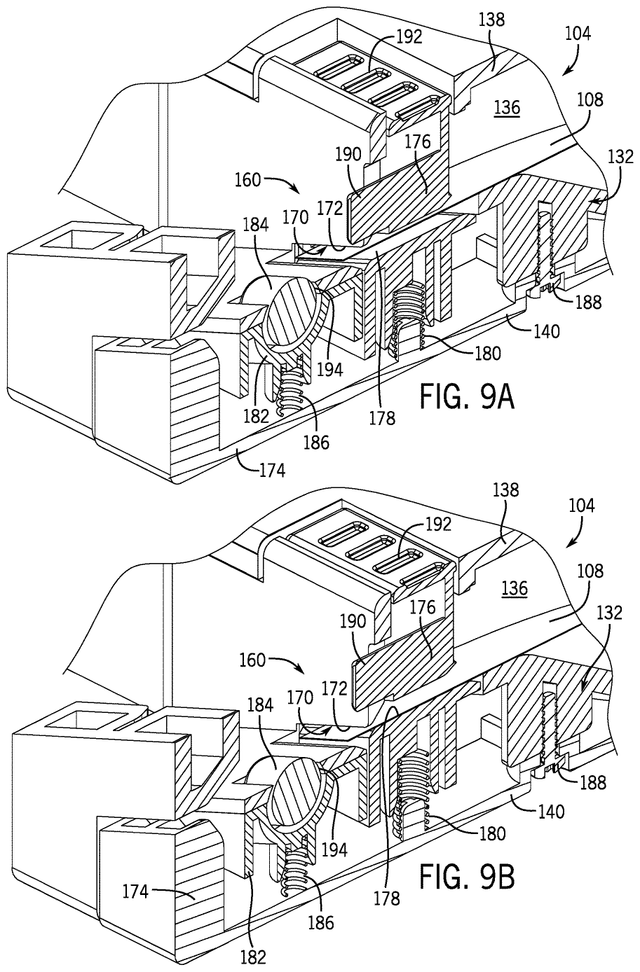

In the exemplary form illustrated, the band clamp 176 at the exit 160 of the cassette housing 132 is received in an underside of the bottom housing portion 140 of the cassette housing 132. The band clamp 176 is biased or sprung upward relative to the bottom housing portion 140 of the cassette housing 132 in which it is received. With further reference being had to FIGS. 9A and 9B, this biasing arrangement involves placing the band clamp 176 in place with respect to the bottom housing portion 140 and securing the removable plate 174 to a lower side of the bottom housing portion 140 (using a screw 188 or using other forms of attachment). Between the upward facing side of the removable plate 174 and a downward facing side of the band clamp 176, the band clamp biasing element 180 is interposed in compression. So placed, the band clamp biasing element 180 will tend to cause the band clamp 176 to be lifted relative to the bottom housing portion 140 (but also ultimately restricted by the bottom housing portion 140 such that the band clamp 176 remains part of the assembly of the cassette 104). This biasing has the result of drawing together the band clamp clamping surface 180 of the band clamp 176 and the band material passage clamping surface 172 of the exit 160 on the bottom housing portion 140 of the cassette housing 132 at which point the band clamp 176 is stopped from further movement away from the removable plate 174.

As the band material 108 will extend between the clamping surfaces 172 and 178 as part of its path out of the cassette 104, when the clamping surfaces 172 and 178 are brought together under the biasing force, they pinch the band material 108 therebetween as depicted in FIG. 9B. This pinching or selective capture of a section of the band material 108 between the clamping surfaces 172 and 178 occurs when the cassette 104 is apart from the band wrapping device 100 (that is, is not inserted into the cassette tray 106 of the band wrapping device 100) and can prevent the band material 108 from moving or sliding into the interior volume 136 of the cassette 104 when the band material 108 is not otherwise fed from the cassette 108 into the band wrapping device 100 (and, more specifically, the band transport mechanism 110). However, when the cassette 104 is inserted in the band wrapping device 100, the band clamp 176 is actuatable against a biasing force applied to the band clamp 176 by the band clamp biasing element 180 to separate the band clamp clamping surface 178 of the band clamp 176 and the band material passage clamping surface 172 at the exit 160 of the cassette housing 132 to release the section of the band material 108 as depicted in FIG. 9A, thereby permitting the band material 108 to be moveable relative through the exit 160 of the cassette housing 132.

Different types of engaging structures between the cassette 104 (and the band clamp 176, specifically) and the band wrapping device 100 could be used to overcome the biasing force applied to the band clamp 176 and move the band clamp 176 to release the band material 108. For instance, in the form illustrated of the cassette 104, the band clamp 176 has an arm 190 projecting therefrom that may contact a part of the band wrapping device 100 or, more specifically, the cassette tray 106 during insertion of the cassette 104 into the cassette tray 106. There could also be an upper band clamp surface 192 that could be depressed to effectuate the release of the band material 108 from between the clamping surfaces 172 and 178.

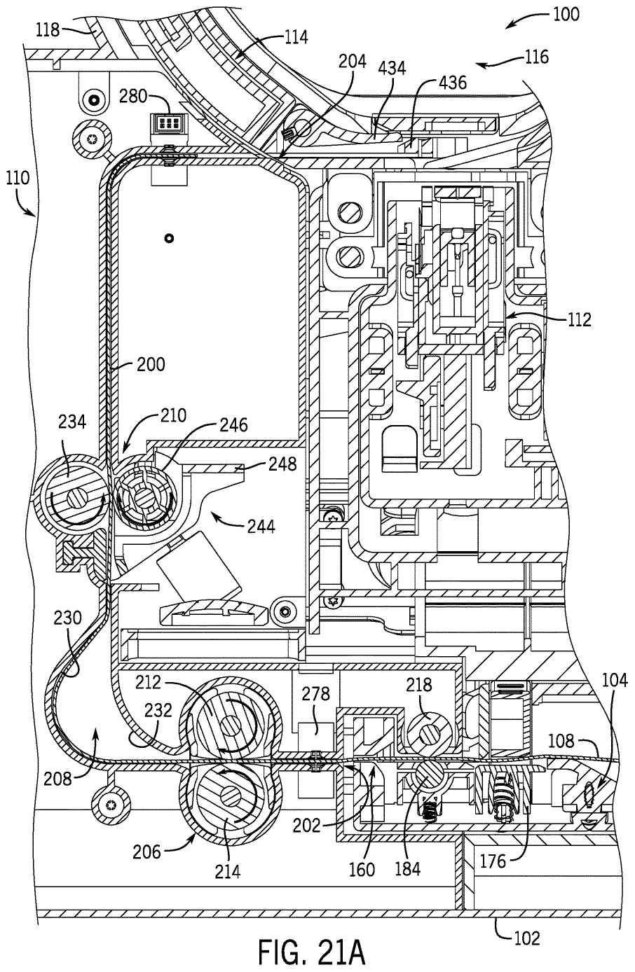

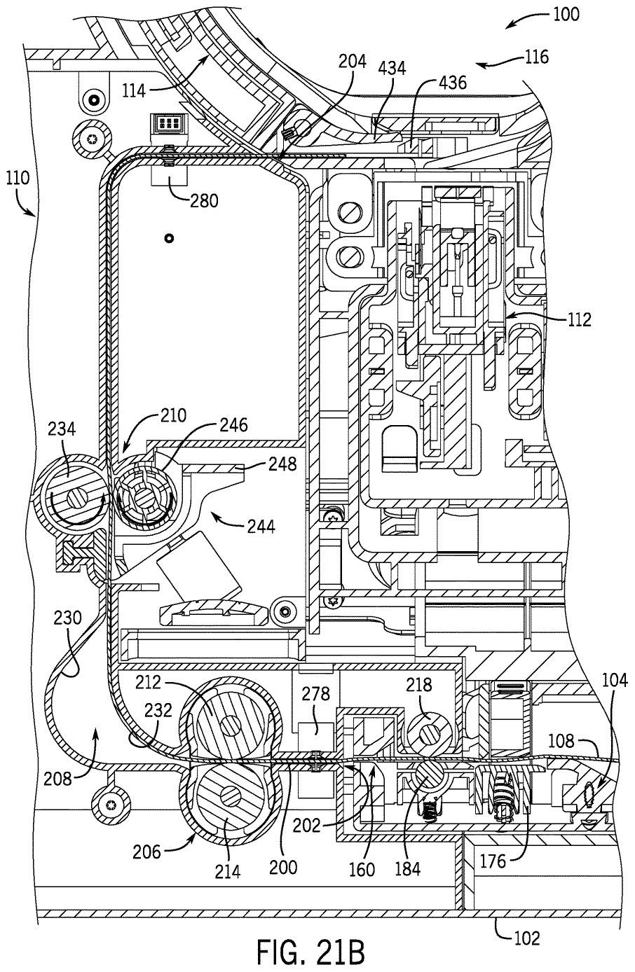

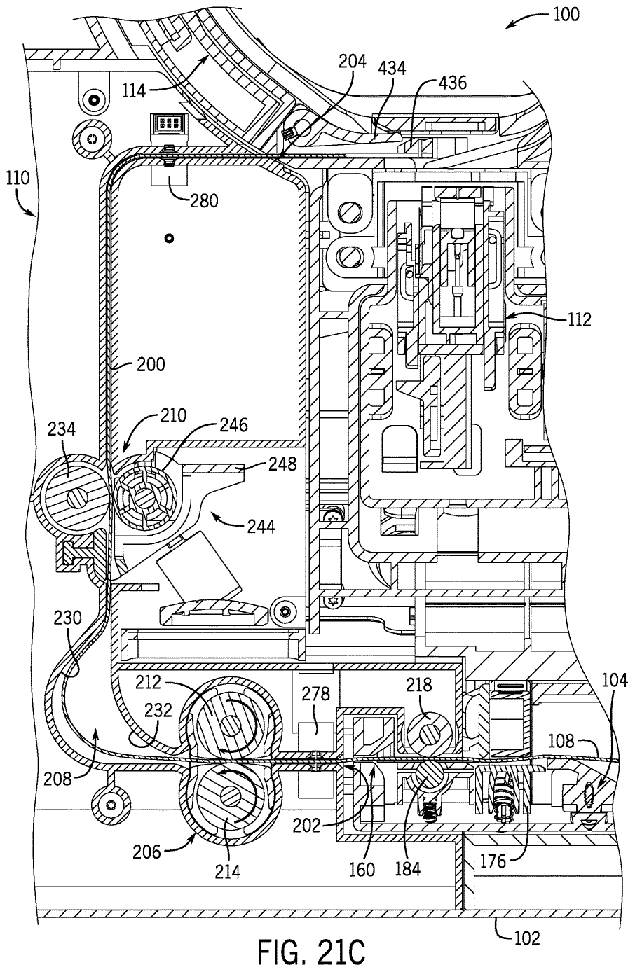

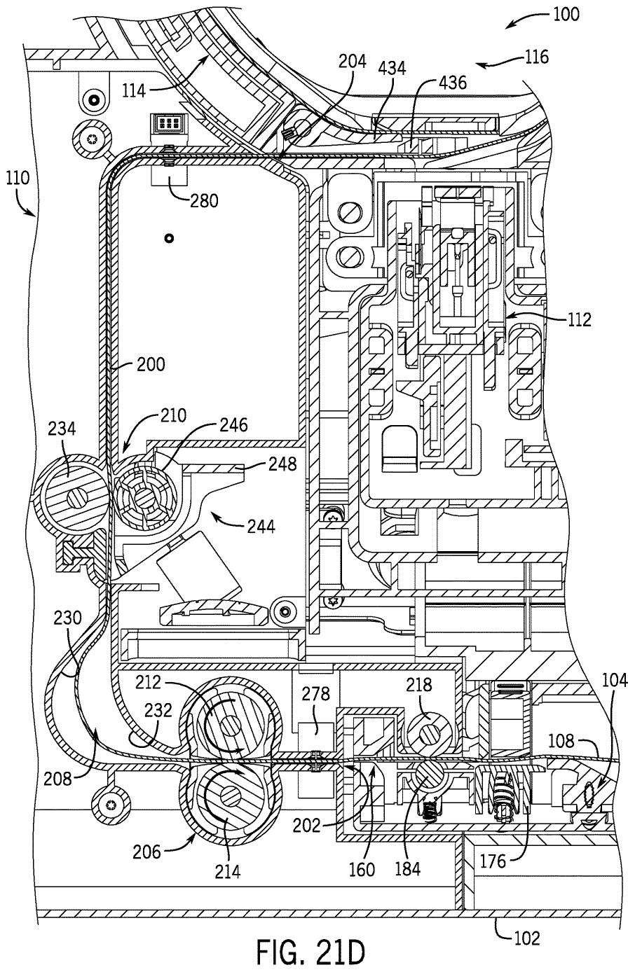

Additionally, proximate the exit 160, the cassette 104 has a sprung idler roller configuration that can, in conjunction with the additional structure of the band wrapping device 100, direct and guide the band material at the exit 160 of the cassette 104 when the cassette 104 is received in the band wrapping device 100. See, for example, FIGS. 21A-21D which show the idler roller 184 and opposing roller after the cassette 104 has been inserted in which the idler roller 184 provides an opposing roller for providing traction with the cassette roller 218. As best seen in FIGS. 7, 8, 9A, and 9B, the idler roller 184 is seated in an upper side of an idler roller holder 182 such that the idler roller 184 is captured between the bottom side of the bottom housing portion 140 of the cassette housing 132 (towards which the idler roller holder 184 is biased) and the removable plate 174 that is attached to the bottom housing portion 140. As can be seen in FIG. 7, the idler roller 184 can have axial ends which nest into semi-circular bearing surfaces in the idler roller holder 182. There is an idler roller opening 194 in the bottom housing portion 140 through which a part, but not all, of the idler roller 184 may project to contact the band material 108 as depicted in FIG. 8. The idler roller biasing element 186 is positioned between the upwardly facing side of the removable plate and the lower side of the idler roller holder 182 to push the idler roller 184 supported thereby into the path of the band material 108 at the exit 160 of the cassette 104 which can be seen in FIGS. 9A-9B as well as FIGS. 21A-21D.

Again, the idler roller 184 proximate the exit 160 of the cassette 104 is configured to provide traction with a mating drive roller in the band wrapping device 100. In general use, the idler roller 184 is biased towards and into a path of the length of band material 108 outside of the interior volume 136 of the cassette housing 132. While the idler roller 184 is generally biased upward relative to the orientations illustrated in FIGS. 7, 8, 9A, and 9B, when an opposing roller is brought into contact with the idler roller 184, as depicted in FIGS. 21A-21D, the idler roller 184 is capable of being defected downward such that the band material is pinched between the idler roller 184 and the mating drive roller.

Lastly, proximate the exit 160 of the cassette 104, there is also another band material passage 196 disposed between the removable plate 174 and the bottom housing portion 140 of the cassette housing 132. When the band material 108 exits the exit 160 of the cassette 104, the band material 108 will pass through the band clamp material passage 170 at the band clamp 176, across the idler roller 184, and out the other band material passage 196.

As best seen in FIG. 5, prior to the exit 160 and internal to the cassette 104, the cassette band material path extends from the spool 134 to the exit 106 of the cassette housing 132. Between the spool 134 and the exit 106, there is a re-directional idler roller 198 positioned along the cassette band material path in which the re-directional idler roller 198 re-directs the path of the length of band material 108 from a first direction (from the spool 134 to the re-directional idler roller 198) to a different second direction (from the re-directional idler roller 198 to the exit 160). Between the re-directional idler roller 198 and the exit 160, the length of band material 108 is twisted relative to the spool axis to re-orient the band material 108 such that the pair of opposing of band surfaces are obliquely oriented with respect to the spool axis within the cassette housing. As depicted, this twist takes the band from a horizontal inclination to one of 70 degrees that is suitable for feeding into the band transport mechanism 110. In other embodiments, the twist takes the band from a horizontal inclination to one of from 60 to 80 degrees, or from 60 to 70 degrees, or from 70 to 80 degrees, or from 65 to 75 degrees, or to 70 degrees. Put differently, the internal section of the cassette 104 between the re-directional idler roller 198 and the exit 160 provides a distance for the band material 108 to be controllably twisted and reoriented, such that the band material 108 is a suitable geometry for exiting the cassette 104 and being received by the band wrapping device 100 and the band transport mechanism 110 specifically as the first part of the band wrapping device 100 into which the band material 108 is received after it exits the cassette 104. And, along this distance of reorientation, the reorientation occurs without inducing buckling or damaging the surface of the band material 108.

In some forms, the cassette 104 further include a consumable protection mechanism. Such consumable protection mechanism may include, for example, one or more of a contact chip or radio frequency identification device to identify the cassette 104 as authentic. By being able to have the band wrapping device 100 authenticate the cassette 104 as genuine, this can ensure that only properly engineered or designed band material is provided into the band wrapping device 100 to avoid the use of counterfeit materials which could, for example, present operability problems in feeding through the counterfeit band material through the band wrapping device 100 or in properly sealing and/or cutting the band material. It is contemplated that such consumable protection mechanism could be part of a pertinent part the cassette 104, whether the cassette housing 132, the spool 134, or some other component of the cassette 104. In some instances, such as where the cassette housing 132 is reused, buy the spool 134 is replaceable, then it may be beneficial to place the consumable protection mechanism on the spool 134, since that portion may ultimately be the portion of the consumable that is replaced.

### The Band Transport Mechanism

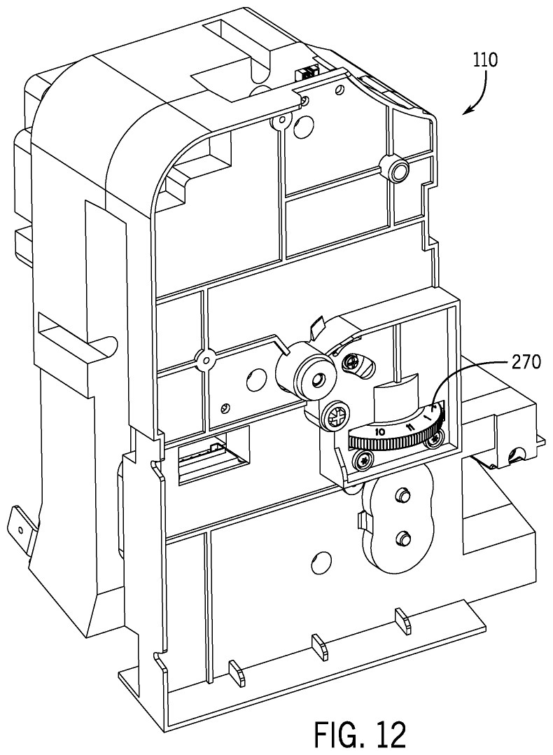

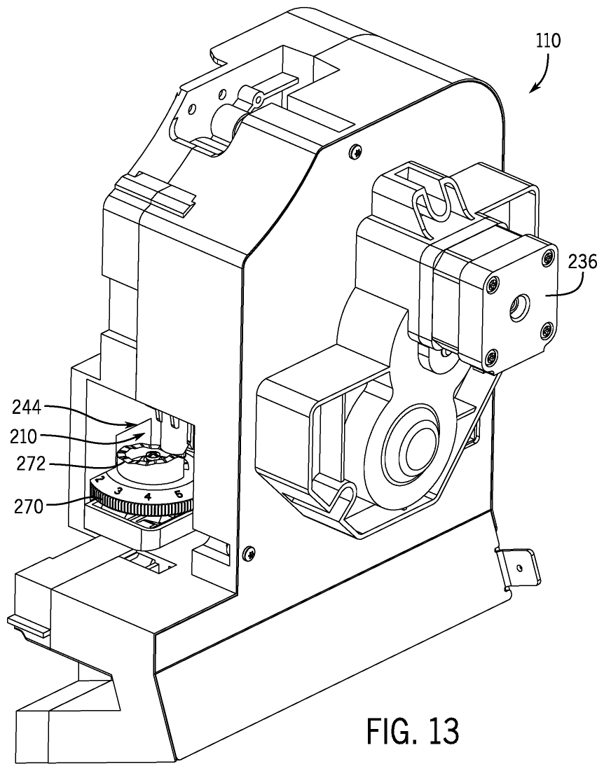

Turning now to FIGS. 11 through 21, the band transport mechanism 110 is illustrated. FIG. 11 illustrates the location at which the band transport mechanism 110 is located within the band wrapping device 100. So, in the exemplary device 100 illustrated, the band transport mechanism 110 is generally on the left side of the machine, with the cassette tray 106 having been positioned on the lower right side as a source of band material 108 when the cassette 104 is inserted. The band transport mechanism 110 can be seen apart from the rest of the band wrapping device 100 in FIGS. 12 and 13 in which the front and back side of the transportation mechanism 110 are shown.

This band transport mechanism 110, as will be described in greater detail below, controls movement of a length of band material 108 along a band transport mechanism path from a source of band material (such as, for example, the cassette 104) to location at which the band will be applied (for example, looped, sealed to itself, and cut such as at the ring module 114 and the sealer module 112). In addition to advancing or reversing the band material 108, this band transport mechanism 110 is operated or controlled to selectively provide tension to the length of band material 108 during a tensioning process during application of the band. It is contemplated that, in some forms of the band wrapping device, a printing mechanism could also be situated along the band transport mechanism 110 to facilitate printing of information onto the band (such as indicia, text, barcodes, or so forth) and this printing mechanism may be positioned close to the exit end of the band transport mechanism 110.

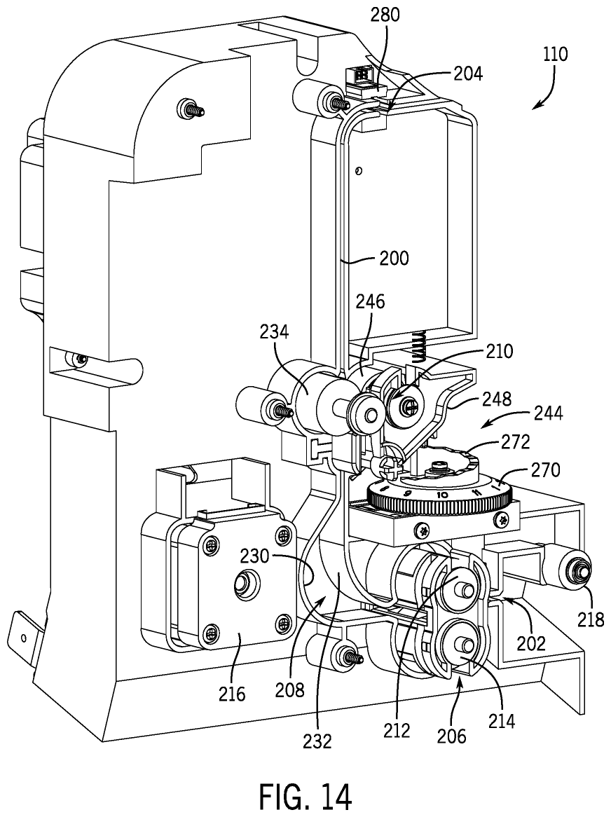

With reference to FIG. 14 which provides a cutaway view of the housing of the band transport mechanism 110, the band transport mechanism 110 includes a band transport mechanism path 200 that extends from a band input channel 202 at a start of the band transport mechanism path 200 to a band output channel 204 at an end of the band transport mechanism path 200. In the orientation shown, this band transport mechanism path 200 is generally C-shaped, starting at the bottom right of FIG. 14, going upward and then towards the upper right corner of the band transport mechanism 110.

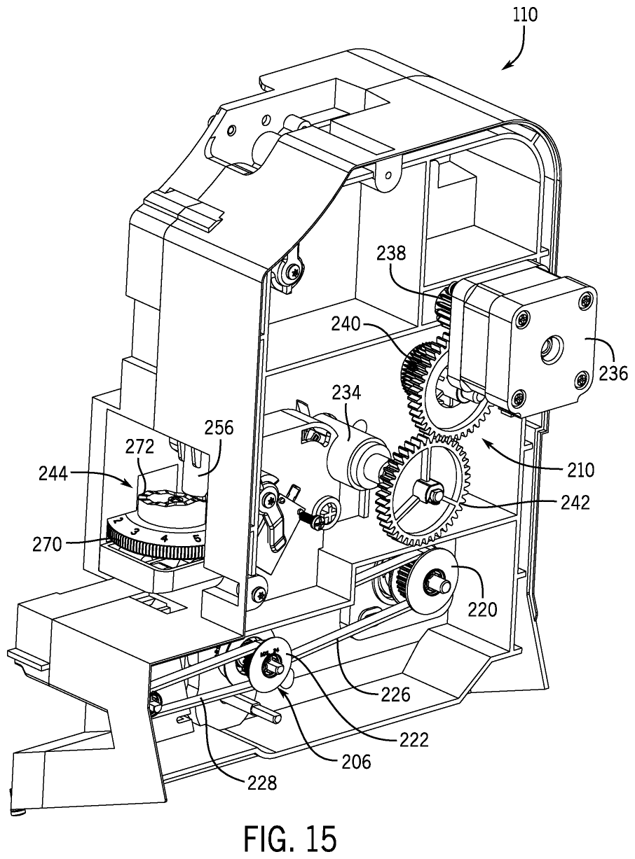

With continued reference begin had to FIG. 14 and further reference being made to FIG. 15, along this band transport mechanism path 200 from the band input channel 202 to the band output channel 204, the band transport mechanism 110 includes a feed mechanism 206, a slack ballast pocket 208, and a band position roller and tensioner set 210. Because of the surrounding housing, FIG. 14 shows the positions of the various rollers and mechanism best along the band transport mechanism path 200, while FIG. 15 shows a cutaway of the opposite side of the band transport mechanism 110 showing the various drive train portions of these components. Each of the various sections or conceptual segments will now be briefly described, in some instances with reference being made to corresponding figures in which those mechanisms are shown in relative isolation from the surrounding structures so they can be better understood.

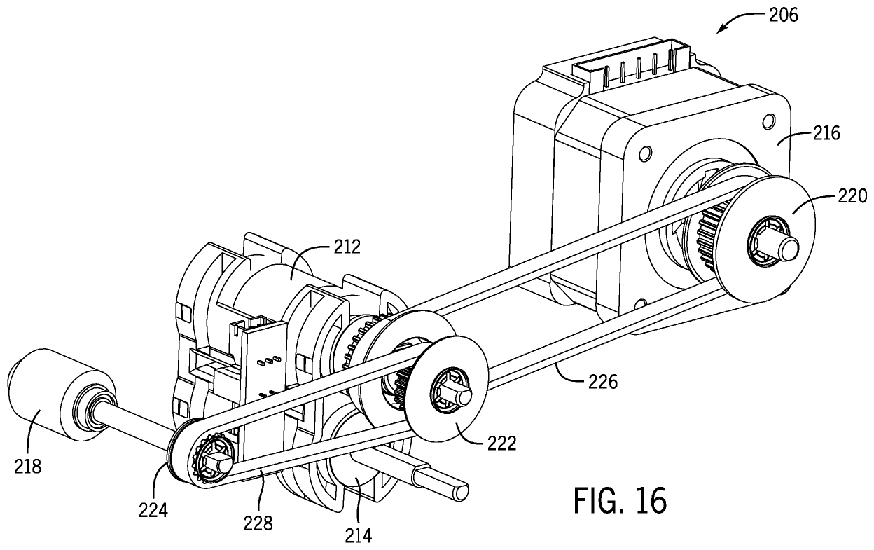

Turning now to FIG. 16, the feed mechanism 206 is shown apart from the rest of the band transport mechanism 110. The feed mechanism 206 includes at least a pair of feed rollers 212 and 214 driven by a feed mechanism stepper motor 216 and can further include a cassette roller 218. It should be appreciated that while a particular belt drive arrangement for the pair of feed rollers 212 and 214 and cassette roller 218 is now described, that alternative arrangements could be used to similar effect or for improved reliability. For example, rather than the arrangement now described, a single gear train might be used. Returning to the figures, a feed mechanism stepper motor pulley gear 220 is attached to an output shaft of the feed mechanism stepper motor 216, a feed roller double pulley gear 222 is attached to one of the feed rollers 212 and rotatable therewith, and a cassette roller pulley gear 224 is attached to the cassette roller 218 and rotatable therewith. A first feed mechanism drive belt 226 connects the feed mechanism stepper motor pulley gear 220 to the feed roller double pulley gear 222 and a second feed mechanism drive belt 228 connects the feed roller double pulley gear 222 to the cassette roller pulley gear 224. The cassette roller 218 is positioned such that, when the cassette 104 is received in the cassette tray 106, the cassette roller 218 is positioned to oppose the idler roller 184 that is provided on the structure of the cassette 104. See, for example, FIGS. 21A-21D.

In the exemplary form shown, when operated, the feed mechanism stepper motor 216 rotationally drives the feed mechanism stepper motor pulley gear 220 to engage the first feed mechanism drive belt 226 to correspondingly drive the rotation of the feed roller double pulley gear 222 and thus the feed roller 212 attached thereto via one of a pair of tracks on the feed roller double pulley gear 222. The other one of the pair of tracks on the feed roller double pulley gear 222 receives the second feed mechanism drive belt 228 that is connected to the cassette roller 218 via the cassette roller pulley gear 224 to also effectuate the rotation of the cassette roller 218 upon the operation of feed mechanism stepper motor 216. All three pulley gears 220, 222, and 224 rotate in the same direction with one another upon actuation by the feed mechanism stepper motor 216. The feed mechanism stepper motor 216 can be driven in either direction to drive the feed roller 212 and the cassette roller 218 in either an advance direction or a reverse direction.

The rotation of the feed roller double pulley gear 222 and at least one of the feed rollers 212 drives the rotation of the other of feed rollers 214. This could be achieved either by, for example, engagement of a drive gear or the like on the shaft of the one of the feed rollers 212 with a drive gear or the like on the shaft of the other of the feed rollers 214 or may occur by virtue of the rotation of feed roller 212 in which the feed rollers 212 and 214 are pressed towards one another such that the rotation of one of the feed rollers (e.g., feed roller 212) creates a counter rotational movement in the other of the feed rollers (e.g., feed roller 214).

As can be best seen in FIGS. 14 and 15, the feed mechanism 206 is positioned such that a portion of the band transport mechanism path 200 extends between the pair of feed rollers 212 and 214 to transport the band material 108 along the band transport mechanism path 200. It is contemplated that the sizing of the various gear pulleys could be roughly equal so that the rotational rates of the feed rollers 212 and 214 are equal to the rotational rates of the cassette roller 218 to uniformly transport the band material 108 received therebetween forward or backward.

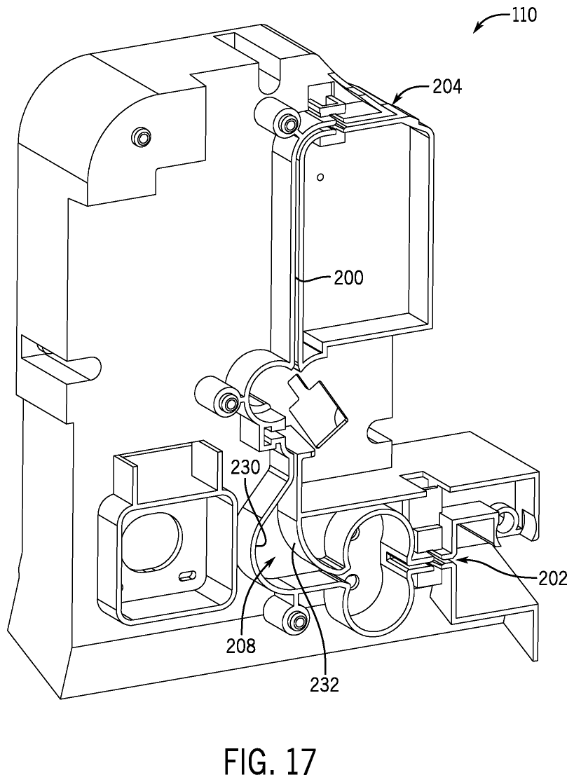

Looking next at FIG. 17, in which the housing of the band transport mechanism 100 is illustrated without the feed mechanism 206 and the band position roller and tensioner set 210, the slack ballast pocket 208 can be seen in isolation along the band transport mechanism path 200. The slack ballast pocket 208 is positioned between the feed mechanism 206 and the band position roller and tensioner set 210 and will provide a section of the band transport mechanism path 200 that is of variable length between those two roller sets.

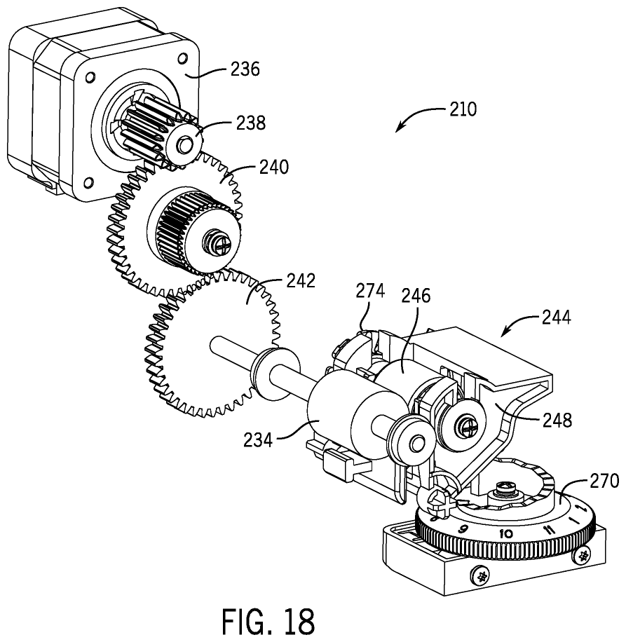

The slack ballast pocket 208 has a pair of opposing slack ballast pocket surfaces 230 and 232 that define a longest path length for the band transport mechanism path 200 in which a maximum slack is provided (from the outer slack ballast pocket surface 230, leftmost on FIG. 17) and a shortest path length for the band transport mechanism path 200 in which no slack is provided (from the inner slack ballast pocket surfaces 232, rightmost on FIG. 18). Thus, given the varied path length, the spacing between the pair of opposing slack ballast pocket surfaces 230 and 232 positionally varies over a portion of a length the band transport mechanism path 200 within the slack ballast pocket 208 with the slack ballast pocket 232 has a shape or geometry generally resembling a stomach. With this shape between the pair of opposing slack ballast pocket surfaces 230 and 232, the spacing increases from the feed mechanism 206 to a maximum spacing within the slack ballast pocket 208. The spacing then decreases from the maximum spacing in the slack ballast pocket 208 to the band position roller and tensioner set 210.

This slack ballast pocket 208 will provide a central region between the feed mechanism 206 and the band position roller and tensioner set 210 at which some slack can be generated in the band material 108 traveling along the band material transport mechanism path 200. As the band material 108 is advanced and reversed, as will be described in more detail below, this provides for some additional slack or length to be created in the slack ballast pocket 208 before the tensioning process begins. Then, upon tensioning the band around the object (i.e., wrist or limb) at ring module 114, there can be some short delay between detecting the band material 108 has stopped moving and halting the driving the components of the band transport mechanism 110, and during this time the additional slack can be consumed.

Turning now to FIGS. 18, 19, and 20, the band position roller and tensioner set 210 is shown apart from the band transport mechanism 110. This band position roller and tensioner set 210 is positioned between the feed mechanism 206 and an exit of the band output channel 204 at an end of the band transport mechanism path 200 and after the slack ballast pocket 208.

The band position roller and tensioner set 210 includes a band position roller 234 driven by a band position roller stepper motor 236. In the form illustrated, the band position roller 234 is driven by the band position roller stepper motor 236 via a drive train of gears including a band position roller stepper motor drive gear 238 connected to the output shaft of the band position roller stepper motor 236, a first band position roller gear 240 having teeth intermeshed with the band position roller stepper motor drive gear 238, and a second band position roller gear 242 having teeth intermeshed with the first band position roller gear 240 and which second band position roller gear 242 is attached to the same shaft as the band position roller 234. In this way, when the band position roller stepper motor 236 is operated, the rotational motion of the band position roller stepper motor drive gear 238 drives a rotation of the first band position roller gear 240 which in turn drives a rotation of the second band position roller gear 242 and the band position roller 234 sharing the shaft therewith. The band position roller stepper motor 236 can be driven in either direction to drive the band position roller 234 in either an advance direction or a reverse direction.

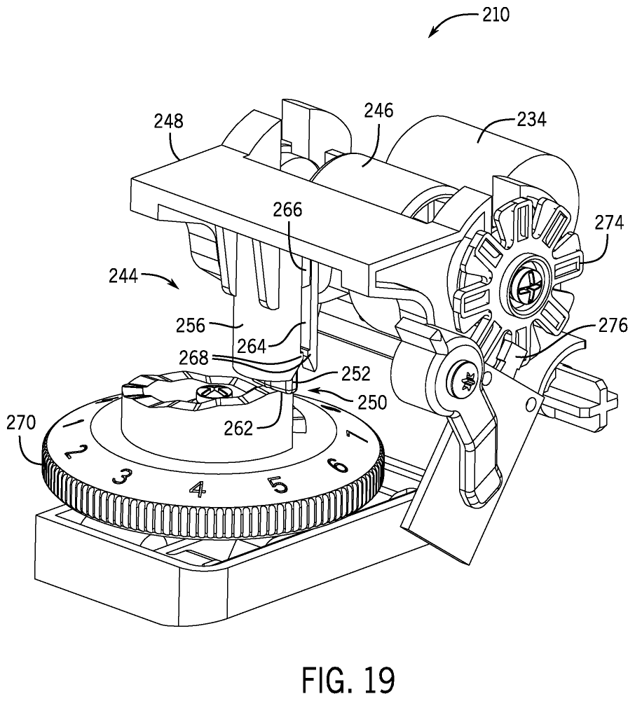

The band position roller and tensioner set 210 further includes a tensioner mechanism 244, which is also shown separately in FIG. 19. The tensioner mechanism 244 includes a tension roller 246 biased toward the band position roller 234 under an applied tensioning force. While the tension roller 246 could be supported in different ways and the biasing of the tension roller 246 toward the band position roller 234 produced in different ways, in the form illustrated, the tension roller 246 is supported by a tension roller support frame 248 which supports the tension roller 246. The tension roller support frame 248 is rotatable about a tension roller support frame axis (defined by the “+” posts extending outwardly from the bottom of the tension roller support frame as seen, for example, in FIG. 18), which axis is offset from the tension roller axis. The tension roller 246 is also rotatable about the tension roller axis for tension roller 246. As can be seen in various figures, the band transport mechanism path 200 extends between the band position roller 234 and the tension roller 246.

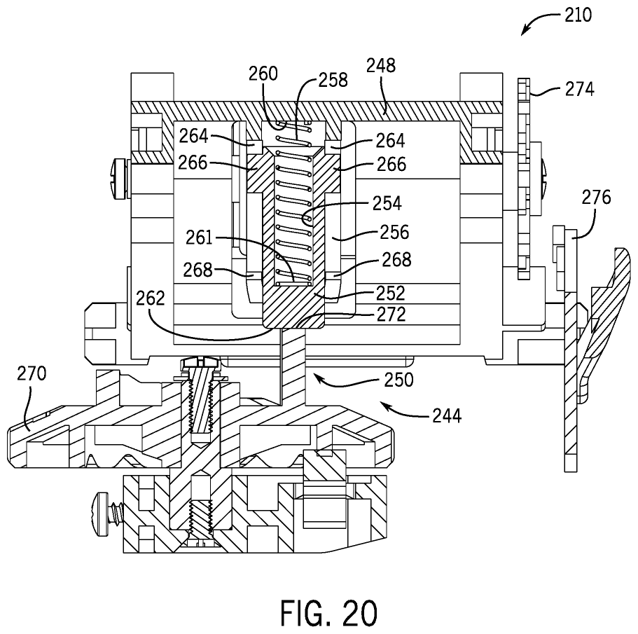

As best seen in FIGS. 19 and 20, to bias the tension roller 246 toward the band position roller 234 via rotation of the tension roller support frame 248, there is an adjustable tension roller biasing mechanism 250 that biases the rotation of the tension roller support frame 248 about the tension roller support frame axis to push the axis of the tension roller 246 toward the axis of the band position roller 234. The adjustable tension roller biasing mechanism 250 includes a plunger 252 with a central spring-receiving channel 254 and this plunger 252 is received in a sleeve 256 formed on a bottom side of the tension roller support frame 248. A tension roller biasing element 258 (here, a spring) is received inside the central spring-receiving channel 254 of the plunger 252, which tension roller biasing element 258 is disposed between an axial end base wall 260 of the sleeve 256 and an axial end base wall 261 of the plunger 252 to push an axial bottom surface 262 of the plunger 252 downward relative to the orientation of the plunger 252 in the sectional view of FIG. 20.

To maintain the plunger 252 within the sleeve 256, as best seen in FIG. 19, the sleeve 256 may be split to provide axially extending channels 264 on the sidewall of the sleeve 256 and the plunger 252 can have corresponding radially projecting fins 266. At the axial end of these channels 264, there can be teeth structures 268 that permit the fins 266 of the plunger 252 to temporarily expand the opening of the channels 264 in the region of the teeth structures 268 to permit the fins 266 to be received in and enter the channels 264 and which retain the plunger 252 within the sleeve 256.

To provide an adjustability in the biasing force applied, the bottom side of the plunger 252 contacts an upper side of a rotatable thumbwheel 270 as best depicted in FIGS. 19 and 20 which is adjustable. In particular, the rotatable thumbwheel 270 has a stepped plunger engagement surface 272 of varying axial height as can be seen in FIG. 19 about the upper surface of the stepped plunger engagement surface 272 as it extends circumferentially around the thumbwheel 270. Accordingly, by rotating the thumbwheel 270 to a particular angular orientation, a particular angular section of the stepped plunger engagement surface 272 can be aligned with the plunger 252. Depending on whether that aligned section is high or low, the plunger 252 is moved to a position in which the tension roller biasing element 258 is more compressed or less compressed and therefore provides a relatively stronger or weaker biasing force to the tension roller 246. By rotating the rotatable thumbwheel 270 to a different angular position, the biasing force applied by the tension roller 246 is thus adjustable. Ultimately, this adjustment allows for incremental adjustment of the final band tension on the user's wrist.

Additionally, the band position roller and tensioner set 210 further includes a magnetic encoder wheel 274 rotatably connected with the tension roller 246 as best shown in FIGS. 19 and 20. This magnetic encoder wheel 274 is connected to the same shaft and rotates in unison with the tension roller 246. Adjacent to the magnetic encoder wheel 274, there is a Hall effect sensor 276. The Hall effect sensor 276 is configured to monitor the rotation of the magnetic encoder wheel 274 on the tension roller 246. As will be described in greater detail below, the rotation of the tension roller 246 (or lack thereof) can be taken as a proxy for whether the band material 108 is being transported while the other rollers are rotating. So, notably, when the band material 108 adjacent to the tension roller 246 stops moving, the tension roller 246 stops moving-even through the band position roller 234 will continue to be driven- and the detection that the tension roller 246 has stopped is reflective that a particular tension has been reached. Increasing the force on the tension roller 246 via the rotatable thumbwheel 270 increases the traction between the band material 108 and the band position roller 234 which, in turn, increases the force required to cause the band material 108 to slip over the surface of the band position roller 234.

Lastly, photo-interrupter sensors can be positioned along the band transport mechanism path 200 to detect the presence of the band material 108 along band transport mechanism path 200. There can be a photo-interrupter sensor 278 between the cassette roller 218 and the pair of feed rollers 212 and 214 as well as a photo-interrupter sensor 280 proximate the band output channel 204. The photo-interrupter sensors 278 and 280 can be configured to detect an edge of the length of band material 108.

It should be appreciated that this views of the band transport mechanism 110 illustrate the feed mechanism 206, the slack ballast pocket 208, and the band position roller and tensioner set 210 as all being supported by part of a single housing that is split roughly vertically (see, for example and in particular, FIGS. 12 and 13). However, the structure of that housing could be different and not all parts of the band transport mechanism 110 need be supported such a long continuous housing. The housing could be split such as into smaller sub-assemblies to improve functionality and precision. As one example, the bottom of the band transport mechanism 110 could be split into a first subassembly that locates the cassette 104, the cassette roller 218, the feed rollers 212 and 214, and forms the slack ballast pocket 208. At this point, the band transport path 200 may extend into a second subassembly that supports the band position roller and tensioner set 210 and extends all the way up to the ring module 114. This can more closely couple the cassette 104 and the slack ballast pocket 208 so that all geometry important to the initial feeding of the band material 108 is controlled in a single subassembly.

With reference now being made to FIGS. 21A-D, these figures illustrate a sequence of band material feeding steps for loading the band material 108 into the band wrapping device, generating slack, and then tensioning the band material as part of the band loop forming process.

Looking first at FIG. 21A, this figure shows initially pulling the band material 108 from the cassette 104 through the feed mechanism 206 and the band position and roller tension set 210. With the cassette 104 inserted into the cassette tray 106, the band material 108 is pulled from the spool 134 of the cassette 104 into the band input channel 202 of the band transport mechanism path 200. The band material 108 is first advanced between the cassette roller 218 and idler roller 184, with the cassette roller 218 being driven by the feed mechanism stepper motor 216. The band material 108 then passes through the feed rollers 212 and 214, which are again driven by the feed mechanism stepper motor 216. After passing through the feed rollers 212 and 214, the band material 108 will enter the slack ballast pocket 208 and enter the region of the band position roller and tensioner set 210. It should be appreciated that while the band material 108 is shown following the outer slack ballast pocket surface 230, that the geometry of the slack ballast pocket 208 as well as the qualities of the band material 108 may dictate how the material is originally placed within the slack ballast pocket 208 and there may be some level of unpredictability or inconsistency on the initial feed of the band material 108 though the band transport mechanism path 200. The band material then passes upward through the band position roller and tensioner set 210, with the band position roller 234 being driven to advance the band material 108 forward up toward the band output channel 204 (and into the ring module 114.

At some point during the initial band advancement process, the band material 108 can be detected to have passed all the transportation components, by for example, the photo-interrupter sensor 280 proximate the band output channel 204. At such point and as depicted by FIG. 21B, the feed mechanism 206 may then be stopped, while the band material 108 continues to be advanced solely by the band position roller and tensioner set 210. During this slack removal operation, the pair of feed rollers 212 and 214 can be held stationary and only the band position roller 234 driven to move the length of band material 108 forward to cause the band material 108 in the slack ballast pocket 208 to follow the shortest path length within the slack ballast pocket 208, until all slack is removed. At that point, the lack of movement of the tension roller 246 can be detected the magnetic encoder wheel 274 and Hall effect sensor 276 and then the band position roller 234 instructed to halt to stop the slack removal operation since it is complete. Accordingly, this operation can remove all slack from the slack ballast pocket 208 as depicted in FIG. 21B as the band material 108 is brought to conformity with the inner slack ballast pocket surface 232. This establishes a known amount of slack (no slack) before the band material 108 is further advanced in the ring module 114 to form a loop.

As illustrated in FIG. 21B, the removal of slack is effectuated by the limited forward movement of the leading end of the band material 108 as a separate discrete step. However, it is contemplated that in other forms, the initial elimination of slack could be achieved in other ways, such as for example, by driving the band position roller and tensioner set 212 at a faster rate than the feed mechanism 206 for a time so that the slack can assuredly be removed.

Once there is a known amount of slack in the band material 108 (again, in this instance no slack), as depicted in FIG. 21C, the band wrapping device 100 can then generate a controlled or known amount of slack in the band material 108 in the slack ballast pocket 208 by advancing only the pair of feed rollers 212 and 214 (and cassette roller 218) while the remainder of the mechanism (primarily the band position roller and tensioner set 210) remains stationary. This forward feed from the cassette 104 while the feeding at the band position roller and tensioner set 210 is not occurring, brings an extra known amount of slack into the slack ballast pocket 208. Because some amount of slack assuredly should be present in the slack ballast pocket 208 prior to any tensioning operation that will follow, this step helps to ensure that such slack is generated in a known amount.

At this point, the feed mechanism 206 and the band position roller and tensioner set 210 may be uniformly advanced until the band material 108 has been appropriately positioned within the ring module 114 for forming a band loop as will be described in greater detail below.

It is also contemplated, however, that the band material 108 could alternatively be advanced into the ring module 114 and positioned to form the band loop in a state of the band material 108 in which it is established that no slack is present in the slack ballast pocket 208 (by, for example, the differential advancement of the band material 108). At that point, the predetermined amount of slack could be generated by the controlled advancement of the feed mechanism 206 without operation of the band position roller and tensioner set 210.

Turning now to FIG. 21D, as part of the band application process, the rollers including both the band position roller and tensioner set 210 and the feed mechanism 206—are rotated in reverse to tension the band material 108 to, for example, reduce the size of the loop around the wrist of a user. As this occurs, both initially rotate in reverse while the band material encounters no resistance. At some point, however, the band material 108, which is fixed at the end of the length is drawn against the wrist of the user as the loop reduces and slightly tightens. At this point, the band material 108 encounters some resistance to being drawn back into the band transport mechanism path 200. Upon continued rotation of the band position roller and tensioner set 210 and the feed mechanism 206, the band material 108 stops traveling through the band position roller and tensioner set 210, but the band material 108 continues at least for a brief period to be pulled back by the feed mechanism 206. When the band material 108 stops traveling through the band position roller and tensioner set 210, the tension roller 246 stops rotating even though the band position roller 234 may continue to rotate as the applied tension between the rollers 234 and 246 is not sufficient to transport the band material 108 creating a “slip condition” for the band position roller 234. When this happens, the Hall effect sensor 276, reading the rotation of the magnetic encoder wheel 274 attached to the tension roller 246, establishes that the tension roller 246 has stopped rotating, indicating the band material 108 has encountered resistance as the band loop was reduced as part of the application process. Detecting this condition, the band wrapping device 100 instructs the band position roller and tensioner set 210 and the feed mechanism 206 to stop operating in reverse to not overtighten the band material 108 in forming the loop. Because there is some delay between the detection of the slip condition and the stoppage of the band position roller and tensioner set 210 and the feed mechanism 206, some amount of the slack (but not all of the slack) in the slack ballast pocket 208 will be consumed as the feed mechanism 206 continues to draw the band material 108 back while the band material 108 has stopped at the location of the band position roller and tensioner set 210. Accordingly, the existence of the slack in the slack ballast pocket 208 prevents a condition in which the band loop is overtightened and provides some extra length of material that can be pulled back during the delay between detecting a taut band material condition and stopping the reversal of the feed. The prevention against overtightening of the band loop is a safety function in that it avoids overtightening of the band material around a person's wrist, a problem that is not recognized or addressed in devices that wrap materials around inanimate objects.

In order to provide some amount of adjustment in the sensitivity of the detection, under the applied tensioning force on the tension roller 246, a clamping force is applied between the band position roller 234 and the tension roller 246 such that, when the band position roller 234 is driven, a rotation of the tension roller 246 is effectuated upon transport of the band material 108 until the clamping force is insufficient and the tension roller 234 stops rotating, thereby causing the band position roller 234 to slip with respect to the band material 108.

Once the band material 108 is formed into a loop in the ring module, drawn taut, sealed together, and cut, then the steps depicted in FIGS. 21B through 21D can be repeated. Namely, the slack of the band material 108 in the slack ballast pocket 208 can be eliminated and then set to a pre-established amount of slack, the band material 108 advanced into the ring module 114 to form the loop and then tensioning process repeated to again form a loop.

So notably and with the operation of the band transport mechanism 110 considered in full, the band position roller and tensioner set 210 (and the tension roller 246 specifically) can be used as a proxy for detecting movement of the band material 108 during the removal of slack and then the band tensioning process during the formation of the band material 108 into a loop in the ring module 114. Thus, the structure of the band transport mechanism 110 acts not only to transport the band material, but also surprisingly as a type of detector or sensor to determine when the band material 108 has stopped moving.

### The Sealer Module

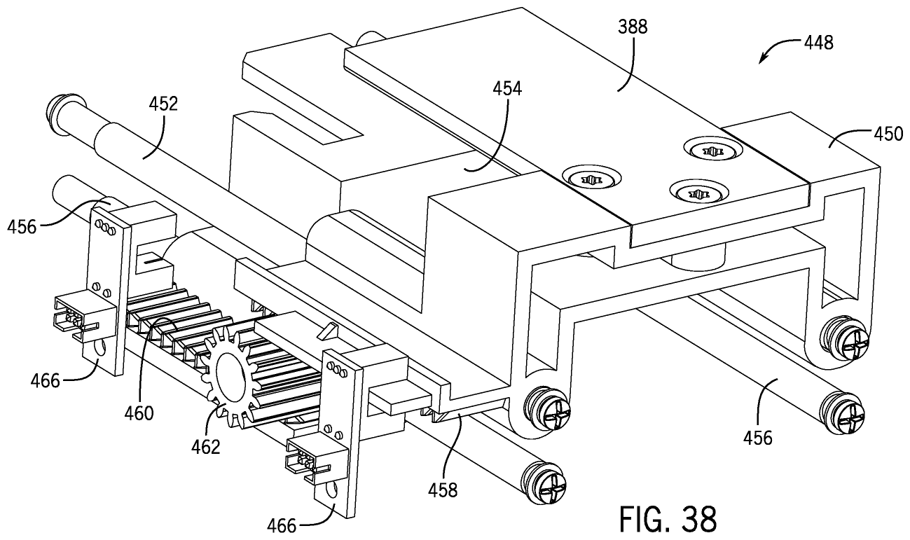

Turning now to FIGS. 22 through 27, the sealer module 112 are illustrated which are, disposed in the band wrapping device 100 such that the sealing face is positioned at the lower end of the ring 118 of the ring module 114. As will be described in greater detail below, the sealer module 112 is actuated to apply heat to the band material 108 to seal it to itself while forming a loop and, in the form shown, to cut or sever the band material 108 formed into a loop from the remaining length of band material 108. In other forms, however, the band material 108 could be cut differently such as by, for example, having a blade attached to the lower side of the anvil 388 such that, upon retraction of the anvil 338 the blade severs the band material 108. In still another form, the blade may be physically located on or supported by the safety cover 454, as seen below in FIG. 38, and the actuation of the safety cover 454 may effectuate the cutting.

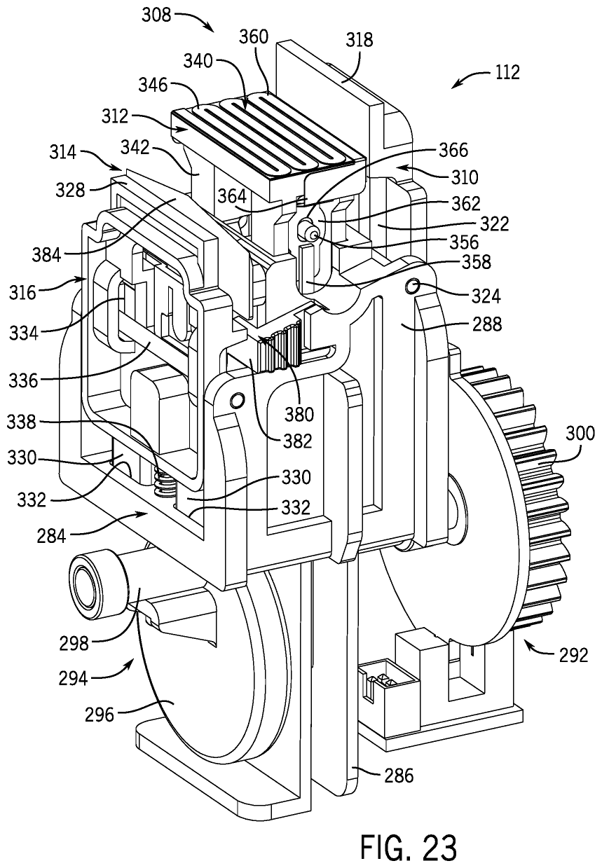

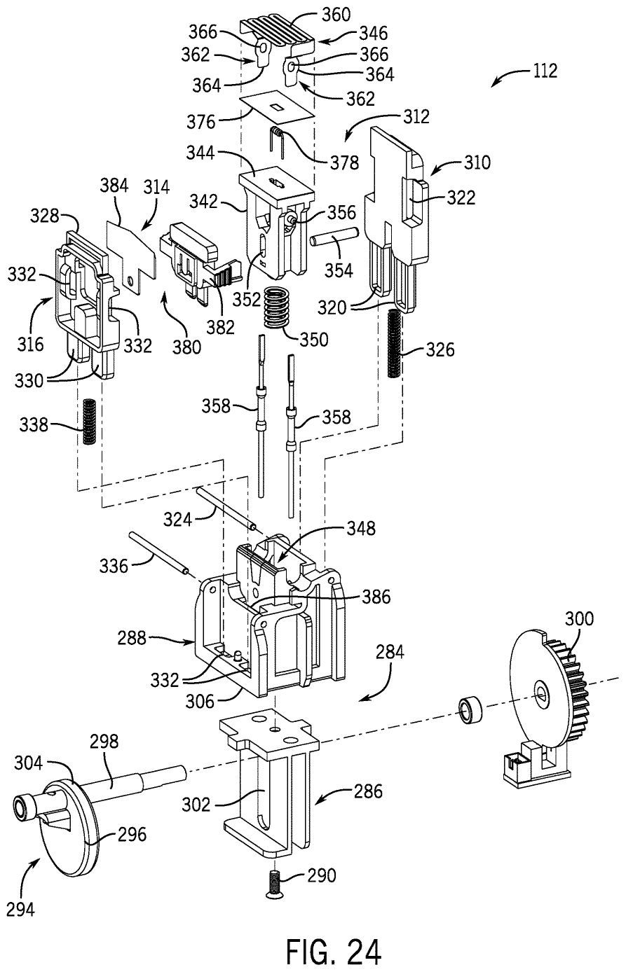

As can be seen in FIG. 22, the sealer module 112 is initially received in a sealer module housing 282 with the pertinent components that do the clamping and sealing (and, in the form illustrated, cutting) being illustrated in dashed lines. For providing better clarity of those components, they are illustrated separately from the housing 282 in FIG. 23 and, because the components are densely packed even as assembled, in an exploded view in FIG. 24.

With reference to FIGS. 23 and 24, the components of the sealer module 112 are now described. The sealer module 112 includes a location block assembly 284 which includes a location block base 286 and a location block frame 288 which can be secured together via fastener 290 such as a screw. Although illustrated as separate components that are fastened together, the location block base 286 and the location block frame 288 could be produced as a single unitary body or might be constructed of more than just the two parts as illustrated.

The sealer module 112 include an actuation mechanism 292 which, in the form illustrated, can include a cam mechanism 294 including a cam 296 which received on a shaft 298 which shaft 298 is connected to driving gear 300 (which driving gear 300 can be driven by a motor or the like which is not shown). As can be seen in FIGS. 23 and 24, the shaft 298 is connected to the cam 296 at a non-center location of the cam 296.

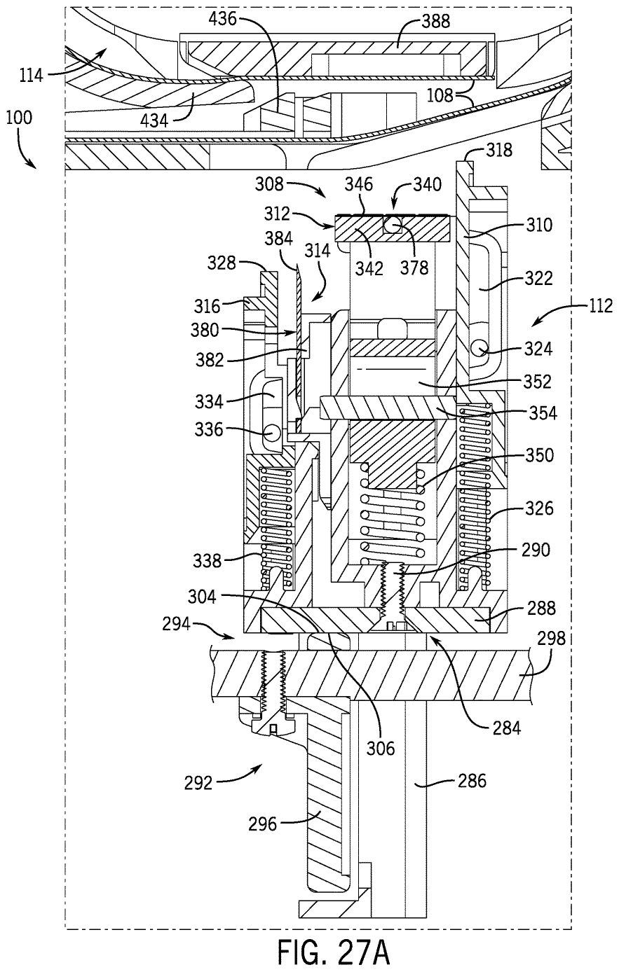

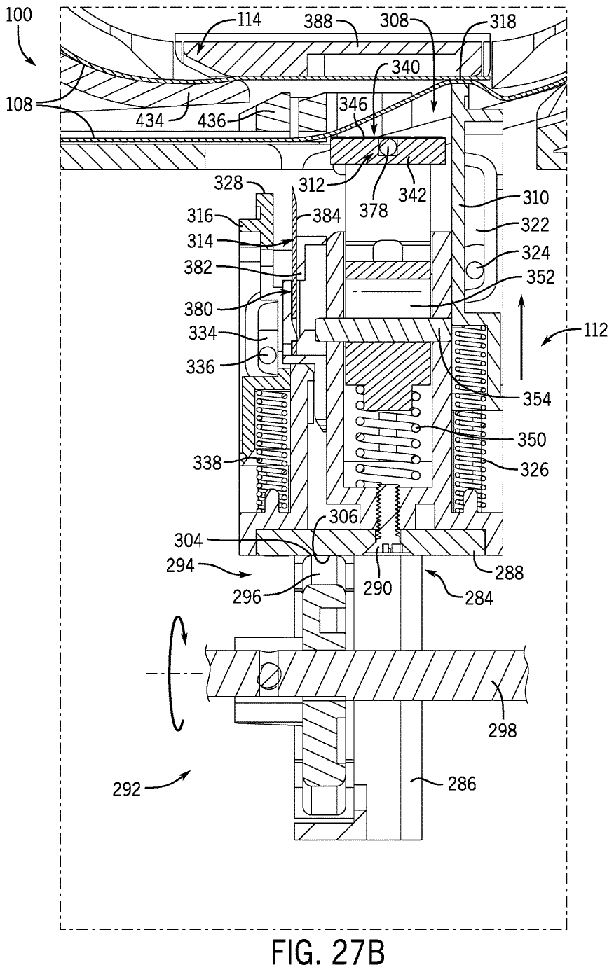

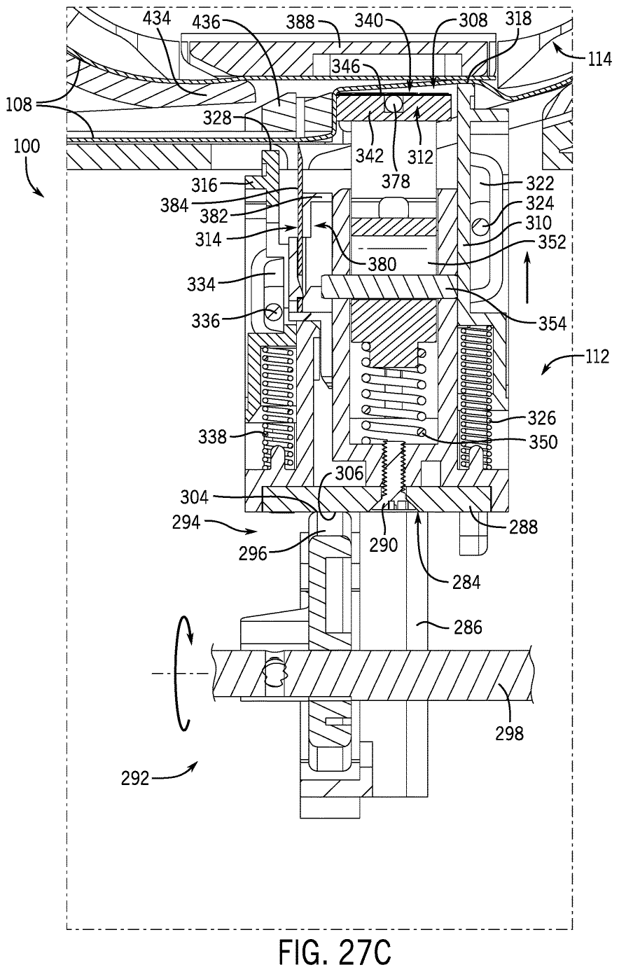

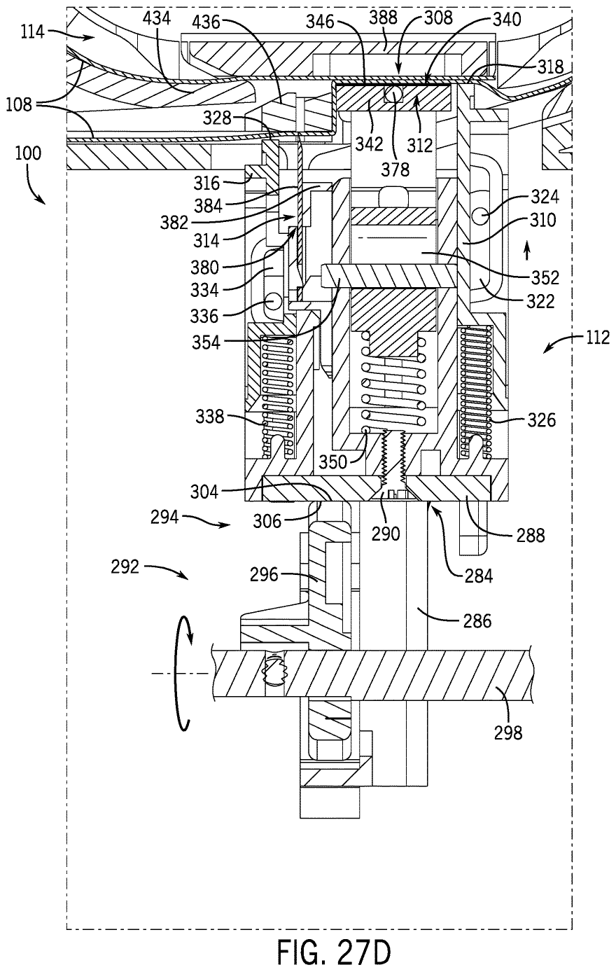

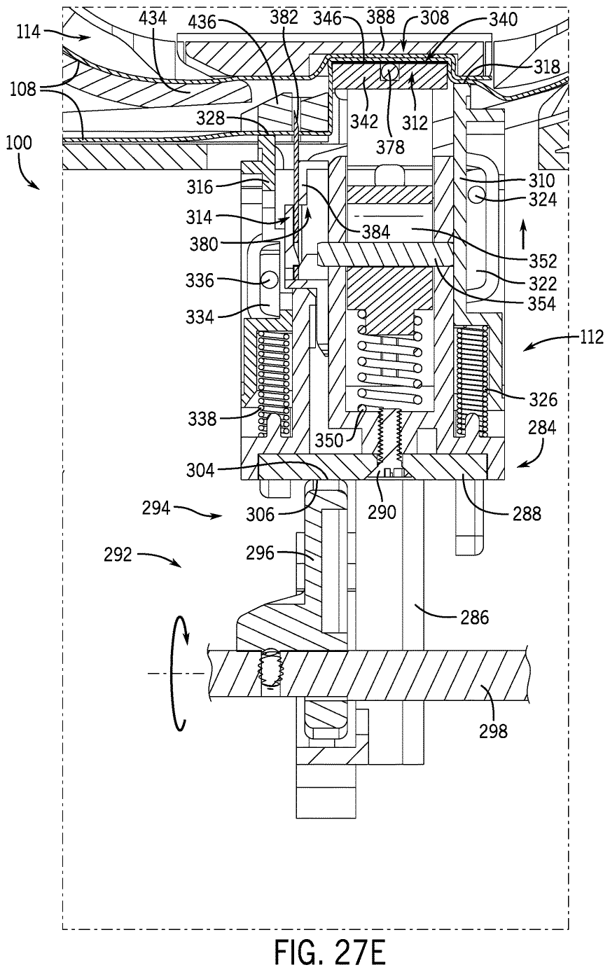

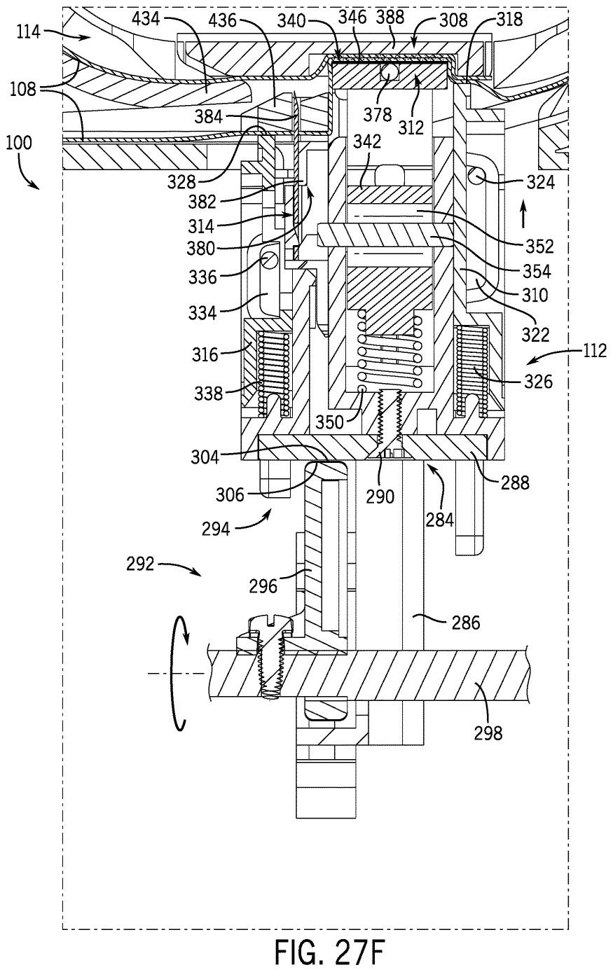

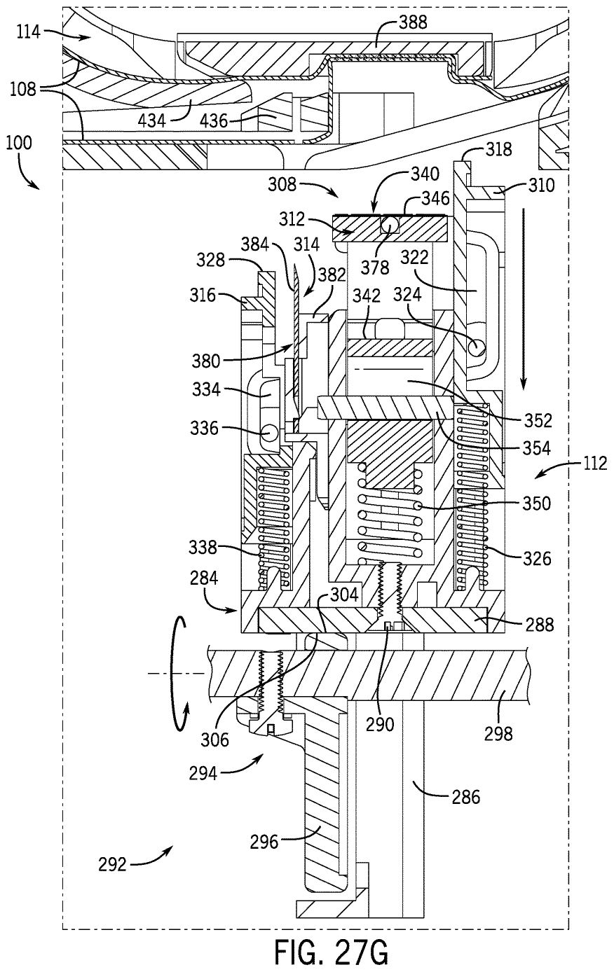

The location block assembly 284, and the location block base 286 specifically, has slots 302 which receive the shaft 298 therethrough. When assembled, as seen in FIG. 23, the cam 296 is positioned on one side of the location block base 286 and the driving gear 300 is positioned on the other side of the location block assembly 284. Accordingly, when the shaft 298 is driven by the driving gear 300 during use, this causes the cam 296 to be rotatable about an eccentric cam axis such that a cam engagement surface 304 of the cam 296 engages a location block cam engagement surface 306 of the location block assembly 284. As the rotation axis of the cam 296 is off center, the rotation of the cam 296 and the engagement between cam engagement surface 304 and the location block cam engagement surface 306 effectuates a translation of the location block assembly 284 as the cam 296 is rotated about the eccentric cam axis, thereby linearly translating the location block assembly 284 and the components received thereon. During this linear translation of the location block assembly 284, the actuation mechanism 292 moves an engagement end 308 of the sealer module 112 from a retracted position (seen, for example, in FIG. 27A) to a band closure position (see, for example, FIGS. 27D, 27E, and 27F) for sealing a band material 108 to itself to form a loop.

It will be appreciated that the rotation of the driving gear 300 or other driving mechanism that effectuates the rotation of the shaft 298 and the cam 296 could be made in different ways such as, for example, alternating clockwise and then counterclockwise rotations to create the translational movement or rotations that could be a full 360 degrees with the resultant movement of the cam being periodic. It will likely be the case, however, that the rotation will not be constant and continuous as-as will be apparent from the description that follows—there will likely be some portions of the clamping and sealing process that will want to be maintained for a duration of time that would be different from the duration if the rotation of the cam was constant. Accordingly, the effectuated rotation of the cam 296 may be stepped or in increments.

The location block assembly 284, and the location block frame 288 specifically in the exemplary form illustrated, carries a plurality of components that are movable with the location block assembly 284 and therefore actuatable by the actuation mechanism 292. These components are perhaps best seen in the exploded view FIG. 24 and include a primary clamp 310, a heater element 312, a cutter mechanism 314 (which may be omitted as depicted in favor of some other type of cutter that may not be supported by the block assembly 284), and a secondary clamp 316 (which secondary clamp 316 may in some instances be omitted). The location block frame 288 is structured to receive these various components and position and/or bias them to achieve the intended result during the operation of the sealer module 112 as depicted in FIGS. 27A through 27G.

As can be seen in FIGS. 23 and 24, in which the location block assembly 284 is shown assembled and exploded respectively, the various components are assembled with respect to the location block assembly 284 in such a way as to provide the desired movement and contact timing of corresponding components in the ring module 114 during use.

Looking first at the primary clamp 310, the primary clamp 310 has a primary clamp surface 318 at an axial end thereof closest to the engagement end 308 of the sealer module 112 and a pair of guide tabs 320 at the opposite axial end thereof. These guide tabs 320 can be inserted to guide openings in the base wall of the location block frame 288 (although the specific guide openings for the guide tabs 320 of the primary clamp 310 are not shown in FIG. 24, they have a similar configuration to those for the secondary clamp 316 shown on the left side of the location block frame 288 in FIG. 24). The primary clamp 310 also includes a pair of pin openings 322 formed through the body of the primary clamp 310. When the guide tabs 320 are received into the corresponding guide openings, a retention pin 324 is received through the location block frame 288 and extends through the pin openings 322 of the primary clamp 310 to retain the primary clamp 310 within the location block frame 288 and to define a linear range of motion or translation for the primary clamp 310 relative to the location block frame 288. There is also a primary clamp biasing element 326 that is received in between a base wall of the location block frame 288 and the primary clamp 310 to bias the primary clamp 310 in the direction of and toward the engagement end 308 of the sealer module 112 until the interaction of the retention pin 324 and the pin openings 322 prevent the primary clamp 310 from further movement toward the engagement end 308. In the position in which the primary clamp 310 is fully extended, the guide tabs 320 remain in the corresponding guide slots to maintain the primary clamp 310 along its displacement path. However, upon the primary clamp surface 318 contacting an item, the primary clamp biasing element 326 can be compressed to permit some amount of deflection of the primary clamp surface 318 and primary clamp 310 relative to the location block frame 288. That is to say, the primary clamp 310 can be displaced into the location black assembly 328 away from its initial position at the engagement end 308.

The secondary clamp 316 has a very similar structure to the primary clamp 310. As with the primary clamp 310, the secondary clamp 316 has a secondary clamp surface 328 at an axial end of the secondary clamp 316 closest to the engagement end 308 of the sealer module 112 and a pair of guide tabs 330 at the opposite axial end thereof. Those guide tabs 330 are insertable into corresponding guide openings 332 formed in the base wall of the location block frame 288 of the location block assembly 284. The secondary clamp 316 also includes a pair of pin openings 334. When the guide tabs 330 are received into the corresponding guide openings 332, a retention pin 336 is received through the location block frame 228 and extends through the pin openings 334 of the secondary clamp 316 to retain the secondary clamp 316 within the location block frame 288 and to define a linear range of motion for the secondary clamp 316 relative to the location block frame 288. There is also a secondary clamp biasing element 338 that is received in between a base wall of the location block frame 288 of the location block assembly 284 and the bottom side of the secondary clamp 316 to bias the secondary clamp 316 toward the engagement end 308 of the sealer module 112 until the interaction of the retention pin 336 and the pin openings 334 prevent the secondary clamp 316 from further movement toward the engagement end 308. As with the primary clamp 310, upon the secondary clamp surface 328 contacting a structure or item, the secondary clamp biasing element 338 can be compressed to permit some amount of deflection of the secondary clamp surface 328 and the secondary clamp 316 relative to the location block frame 288 of the location block assembly 284.

The sealer module 122 also includes the heater element 312 having a heatable face 340 that is used to melt the adhesive on one side of the band material 108, or to bond the band material 108 to itself, during the band attachment process. The heater element 312 includes a heater platform 342 with an upper face 344 supporting a resistive heating element 346 and a bottom end that is shaped to be received in a vertical receiving channel 348 between the primary clamp 310 and the secondary clamp 316 as best shown in FIG. 24. To provide good resistance to heat, the heater platform 342 may be composed of a polyetheretherketone (PEEK) material. There is a heater element biasing element 350 in the form of spring inserted between a base wall of the location block frame 288 and the lower side of the heater element 312 (and more specifically, the heater platform 342). The heater element biasing element 350 provides an upward biasing force on the heater element 312 relative to the location block assembly 284 and the heater platform 342 of the heater element 312. To restrict the upward movement of the heater element 312, the heater platform 342 can include guidance slots 352 through which a control pin 354 is received in which the control pin 354 is positionally fixed in the location block frame 288. The heater element 312 also includes a set of terminals 356 on the sides thereof which are connected to electrical wires 358 which can be inserted through the bottom of the location block assembly 284 (see for example, the openings on the top side of the location block base 288 in FIG. 24). These wires 358 and their connected terminals 356 can be connected to a power supply for effectuating the resistive heating of the heater element 312.

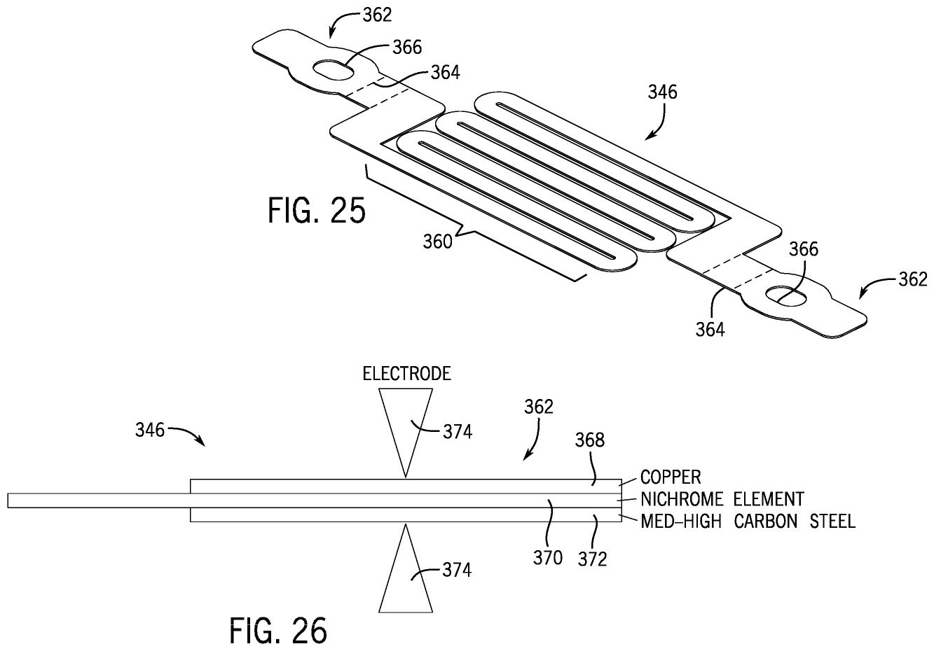

With additional reference being made to FIG. 25, the resistive heating element 346 of the heater element 312 can be fabricated from a nichrome material which, in the exemplary embodiment show, is a nickel-chromium alloy material that is 80 weight percent nickel and 20 weight percent chromium as this alloy is particularly receptive to resistance heating. The resistive heating element 346 has a serpentine section 360 on the face for contacting the band material 108 to provide a large area that can be heated while also providing the geometry that is conducive to resistance heating.

At both ends of the serpentine section 360 there is a terminal connector 362 which is a tab 364 with an opening 366 for reception at the respective terminals 356 (see FIGS. 23 and 24) after being bent down for soldering to the wires 358. Because the nichrome material of the resistive heating element cannot be directly soldered to, this presented a significant engineering challenge in the development of the heating element 312. A specific construction and spot-welding technique were developed to permit the use of the nichrome material and permit it to be soldered in this application. As can be seen in the schematic of FIG. 26, the terminal connectors 362 include multiple stacked layers of material including a copper layer 368, the nichrome element layer 370 that extends on to form the serpentine section 360 (without the other layers), and a medium to high carbon steel layer 372. These layers are spot welded together using set of opposing electrodes 374 to join the layers 368, 370, and 372. This permits the terminal connectors 362 to be soldered to the terminals 356. It does present a limitation that both the copper layer 368 and the steel layer 372 will corrode preferentially over the nichrome element layer 370 and so the resistive heating element 346 with this construction may have a shorter useful life that might be desired, especially in humid environments.

Additionally, this overall construction of the resistance heating element 346 is beneficial because, during operation, power is supplied across the terminal connectors 362 and through the serpentine section 360 and the electrical resistance through the serpentine section 360 is used to generate the heat for melting the adhesive of the band material 108 or otherwise joining the band material 108 to itself. Due to internal resistance and a very small thickness (only around 0.125 mm), the material of the resistive heating element 346 can heat up very quickly. Still further, by having relatively large terminal connectors 362 and by reducing the thickness of the resistive heating element 346 and having a narrower serpentine geometry (that is, doubling back and forth from one side of the rectangular upper face 344 to the other side of the rectangular upper face 344), the cross-sectional area of the resistive heating element 346 along the path of electrical flow can be made relatively small, while the overall amount of material present for heating can still be made large in the area to be heated. This concentrates the heat generated toward the serpentine section 360 on the upper side of the heater element 312 and ensures even heat distribution across the area of the heatable face 340 that will contact the band material 108.

During assembly, the resistive heating element 346 can be adhered to the upper face 344 using a layer of adhesive 376 such as a high temperature resistant adhesive. This can allow for precise and maintained placement of the resistive heating element 346 relative to the upper face 344.

Additionally, a heatable face cover may also be applied over the resistive heating element 346 and this the heatable face cover may be a polytetrafluoroethylene (PTFE) material. This face cover can prevent excess adhesive that melts from the band material from protruding through the area between the resistive heating element 346 in the serpentine section 360.

Lastly, beneath the resistive heating element 346, the heater platform 342 can house a thermistor 378 in a pocket of the upper surface. This thermistor 378 can act as a temperature sensor which helps to determine the approximate temperature in the resistive heating element 346 during operation.

It is contemplated that, in some forms, rather than a resistive heating element 346 being present at the heatable face 340, ultrasonic bonding could be used to join the band material 108 to itself in the overlapping region. For example, a sonotrode could be used at the face of the heater element 312 to generates friction and heat at the heatable face 340. With such ultrasonic bonding, the anvil 388 could still be used in opposition to the ultrasonic bonding element of the heater element 312, with the overlapping band material 108 positioned therebetween.

Again, as with the primary clamp 310 and the secondary clamp 316, the heater element 312 can travel both with the movement of the location block assembly 284 when the location block assembly 284 is actuated by the actuation mechanism 292 and can slide within the location block assembly 284 by virtue of being sprung or biased relative thereto.

Finally, in consideration of the construction of the sealer module 112, the sealer module 112 optionally includes a blade assembly 380 including a blade housing 382 and a blade 384 attached thereto as part of the cutter mechanism 314. The blade housing 382 is directly received into a cutter mechanism slot 386 in the location block frame 288 as best seen in FIG. 24 between the heater element 312 and the secondary clamp 316. Accordingly, when the location block assembly 284 moves, so correspondingly does the cutter mechanism 312 and the blade 384.

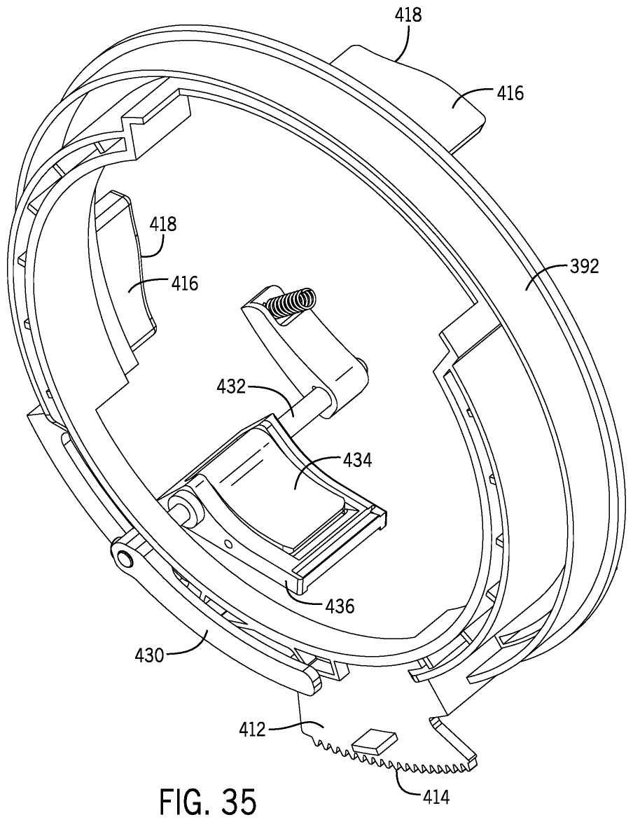

Now, with further reference to FIGS. 27A through 27G, the operation of the sealer module 112 will be described in more specific detail during the formation of a loop from the length of band material. Although it will be described in greater detail below with respect to the ring module 114, it should be appreciated that the engagement end 308 of the sealer module 112 will be driven towards an anvil 386 (which is shown in FIGS. 35 through 37 more clearly). The anvil 388 is retractable and positionable in opposition to the engagement end 308 of the sealer module 112 and will provide an opposition surface for the clamping and heating operations. In FIGS. 27A through 27G, the anvil 386 is extended to an anvil sealing position, but the anvil 388 can be retracted to permit the formed band to be removed from the band wrapping device 100.

Looking first at FIG. 27A, the sealer module 112 is shown apart from the overlapped region of the band material 108. At this point in time, the band material 108 has been fed into the ring module 114 (which will be described in greater detail in the next section) by the band transport mechanism 110 and fed forward to such a point at which the band material 108 has established the overlapped region. In this position and at this time, the anvil 388 is projected out to oppose the engagement end 308 of the sealer module 112 and the terminal free end of the band material 108 is clamped to permit the looped material to be tensioned. Indeed, while it is not depicted in FIGS. 27A through 27G, before the sealer module 112 is operated, the band material 108 will be tensioned and sized to the wrist of the user so that subsequently described operations on the band material 108 by the sealer module 112 will seal the band material 108 with the loop appropriately sized.

In FIG. 27A, the cam 296 is rotated to a position in which the sealer module 112 is retracted from the anvil 388. As depicted here, the components at the engagement end 308 of the sealer module 112 are spaced from the anvil 388 and, as there is no pressure applied to the components, they are biased or sprung to their fully extended position. As can be seen in this view, the primary clamp surface 318 of the primary clamp 310 is the closest to the anvil 388, followed by the heatable face 340 of the heater element 312, followed by the blade edge of the blade 384, followed by the secondary clamping surface 328 of the secondary clamp 316. In this view (and with further comparison to the subsequent figures in which they move or encounter resistance), it can also be better seen how the positions of the primary clamp 310, the heater element 312, and the secondary clamp 316 are established when there is no opposing force. For example, in the case of the primary clamp 310, the primary clamp 310 is biased upwards by the primary clamp biasing element 326 until the retention pin 324 engages the bottom end of the pin openings 322 for the primary clamp 310 to prevent further upward movement. Likewise, in the case of the secondary clamp 316, the secondary clamp 316 is biased upwards by the secondary clamp biasing element 338 until the retention pin 336 engages the bottom end of the pin openings 334 to prevent further upward movement of the secondary clamp 316. Because of the viewing angle of the figures, it is more difficult to conceptualize this for the heater element 312, but the heater element biasing element 350 urges the heater element 312 upward until the control pin 354 engages a lower end of the guidance slot 352 in the heater platform 342 (that slot 352 is perpendicular to the slots 332 and 334 and so is largely in the plane of the page).

In FIG. 27A, the band material 108 has been formed into a loop having an overlapping region just above the sealer module 112 and the band material 108 clamped right as the band material 108 approaches the anvil 388, while leaving some additional length for sealing in the region of overlap. It should be appreciated that, before the remaining sealing and cutting steps have occurred, the band material 108 has been tensioned by the band transport mechanism 110 to form a sized loop around the wrist of the user and so the band material 108 is appropriately positioned for the sealing and cutting steps.

Turning now to FIGS. 27B, 27C, and 27D, the advancement of the engagement end 308 of the sealer module 112 towards the anvil 388 with the band material positioned therebetween results in the initial clamping of the band material 108 in the overlapping region (as in FIG. 27B) and then contact of the heatable face 340 of the heater element 312 with the band material 108 in the overlapping region (as in FIGS. 27C and 27D). As can be seen from a comparison of the actuation mechanism 292 in FIGS. 27A, 27B, 27C and 27D, the use of the cam mechanism 294 and rotation of cam 296 forces the location block assembly 284 upward by engagement of the cam engagement surface 304 with the location block cam engagement surface 306. This effectuates the upward movement of the entire assembly relative to the anvil 388.

From FIG. 27B, as the upward actuation of the location block assembly 284 occurs, the primary clamp surface 318 is the first component of the engagement end 308 to contact the band material 108. At this point, and with further upward actuation of the location block assembly 284 as depicted in FIGS. 27C and 27D, the heater element 312 (and the heatable face 340, in particular) is drawn into contact with the band material 108 to locate the band material 108 between the heatable face 340 and the anvil 388 so a sealing operation can occur upon heating of the heatable face 340 by powering the resistive heating element 346 and causing it to heat up after full contact with the band material 108. Comparing FIGS. 27C and 27D, these figures depict the progressive advancement of the location block assembly 284 and the engagement end 308, and the biased nature of the primary clamp 310 allows that primary clamp 310 to initially make contact during clamping (FIG. 27B) and then deflect downward relative to the rest of the location block assembly 284 (FIGS. 27C and 27D). To appreciate and see this deflection, the amount of compression of the primary clamp biasing element 326 can be compared from one figure to the other as well as the location of the retention pin 324 (which is fixed relative to the location block assembly 284) and the pin openings 322.

Still further, in FIG. 27D, the blade edge of the blade 384 begins to engage and cut the band material 108. Ultimately, upon further upward actuation of the location block assembly 284 (to which the blade 384 is fixed) the band material 108 will be cut such that the looped length of band material in the ring module 114 (which is/will be sealed) is severed from the length of band material 108 coming from the band transport mechanism 110.

Looking further now at FIGS. 27E and 27F, in which the engagement of the engagement end 308 of the sealer module 112 towards the anvil 388 is advanced by further upward movement of the location block assembly 284 (again, by further rotation of the cam 296 as part of the actuation mechanism 292), three things occur.

First, the secondary clamp surface 328 begins to clamp the band material 108. So clamped, the band material 108 would be first be restricted at both the primary clamp surface 318 of the primary clamp 310 (as well as by the adjacent heatable face 340 of the heater element 312 as that advances) and then subsequently the secondary clamp surface 328 of the secondary clamp 316. The timing of the contact and clamping matters here because, given that the heater element 312 establishes a stepped profile in the band path (compare the band path in near the heater element 312 in FIGS. 27B, 27C, and 27D), the secondary clamp 316 should not be applied until the path the band material 108 is established. Otherwise, the heater element 312 might be brought into a length of band material 108 that is pinned on either side, and this could stretch/damage the band material or cause band engagement between the heatable face 340, the band material 108, and opposing anvil 388.

The second thing that occurs during the advancement as shown in FIGS. 27E and 27F is that, roughly contemporaneous with the clamping of the second clamp 316, the blade 384 travels with the location block assembly 284 to fully sever the band material 108. With the clamps 310 and 316 in place as well as the heater element 312, this means that the point of severance can be established and the surrounding areas of the band material 108 are well supported for making the cut. As this cut occurs, it can again be seen from the comparison of the biasing elements, retention pins, and slots of the clamps 310 and 316 and heater element 312 to earlier figures in the sequence, that the clamps 310 and 316 and heater element 312 can stay in place relative to the anvil 388 (albeit under increased force) while the location block assembly 284 continues to be advanced to actuate the blade 284 upward for making the cut.

Lastly, the third thing that occurs in FIGS. 27E and 27F is that the heater element 312, and more specifically the heatable face 340, is pressed into the band material 108 and the anvil 388. Comparing FIGS. 27E and 27F, if one notes the heater element biasing element 350 and the location of the control pin 354 within the guidance slots 352, the heater element 312 can be seen to be displaced down into the location block assembly 284. As noted above, this can accommodate the further upward actuation of the blade 384, but also applies an increased pressure while the heatable face 340 is heated to join the band material 108 to itself.

As mentioned earlier, the band material 108 can include a heat-responsive adhesive on at least one side thereof and so, at this point the resistive heating element 346 is powered. By heating the heatable face 340 and pressing it against the band material 108 with the anvil 388 opposing it, the band material 108 can be joined and sealed to establish a sealed loop. Again, it is contemplated that, in some forms, no adhesive may be present and the band material 108 may be heated and bonded to itself. It is contemplated that the location block assembly 284 may be maintained in the position illustrated in FIG. 27F with sufficient time to effectuate the sealing or closure of the band and so there may be some longer dwell time in this position relative to the other positions which may be less time sensitive.

Since the band material 108 is also severed, this sealed loop is thus separate from the remainder of the length of band material. With the band material 108 having been sealed and cut, the engagement end 308 of the sealer module 112 can be retracted as depicted in FIG. 27G by further use of the actuation mechanism 292 and rotation of the cam 294. All the components supported by the location block assembly 284 spring back under their biasing forces and the heatable face 340 is cleared from the anvil 388 (and covered with another cover as will be described below) to ensure that the engagement end 308 cannot contact the user since it includes hot and sharp components. The anvil 388 is subsequently retracted so that the sealed loop on the user's wrist can be removed from the ring module 114. At this point, once the band material 108 is advanced and the loop formed and tensioned again, the sealing and cutting operation can be repeated.

It is contemplated that, in some forms, the sealer module 112 may not support a blade, blade assembly, or cutter mechanism and that the sealer module 112 may simply seal the material to itself. In such alternative embodiments, the cutting or severing of the band material 108 from the looped band can be differently achieved. For example, it is contemplated that a blade may be attached to the anvil 388. Rather than having a blade puncturing the band material as described and depicted herein, the retraction of the anvil 388 could pull a small circular blade across the band material 108, similar to a paper trimmer. In this way, the blade or a cutter assembly need not necessarily be part of the sealer module 112 and it is contemplated that the movement of the anvil 388 or the safety cover 454 (discussed below which also moves to cover the sealing module 114 to prevent any hot surfaces from coming in contact with the user) could be used to effectuate the cut with the blade being supported on one of those elements. In such case, it will be understood that the timing and order of operations may be slightly different that those described above as the sealing will first occur before the anvil is retracted and so the band only is cut contemporaneously with the retraction of the anvil 388 (not before the retraction) or the movement of the safety cover 454. Additionally, because the movement of the anvil 388 or safety cover 454 would articulate the blade in that embodiment, it may then be appropriate to ensure the anvil 388 is moved back to the extended position before the next length of band material 108 is fed into the ring module 114 and/or otherwise account for the position of the blade and other elements prior to feeding the band material 108 into the ring module 114.

Having described the overall structure and operation of the sealer module 112, one of the major benefits and advantages of this structure can be appreciated. Notably, from the prior description, while there are multiple components (the primary clamp 310, the secondary clamp 316, the heater element 312, and the blade assembly 380), there only is a single point of actuation in the actuation mechanism 292 and a single lifted assembly. Thus, there does not need to be three or four independently operable drives to control each of these components individually. Rather, given the disclosed structure involving multiple biased elements independently movable relative to the location block assembly 284 (and a blade 294 fixed thereto), a complex engagement action of the engagement end 308 of the sealer module 112 can occur with a single translational action. As demonstrated, this complex action could be performed by the simple rotation of a cam 294, appropriately timed.

### The Ring Module

Turning now to FIGS. 28 through 39, the ring module 114 is shown along with the associated anvil 388. For the sake of illustrating the positioning of the ring module 114 in the band wrapping device 100, FIG. 28 shows the ring module 114 and anvil 388 in dashed lines. This ring module 114 receives the band material 108 from the band transport mechanism 110 and forms a loop out of it as the band material 108 fed around the ring 118. Near the bottom of the ring 118, the anvil 388 and previously mentioned sealer module 114 are positioned.

The ring module 114 is the location at which the user primarily interacts with the band wrapping device 100 by insertion of their limb into the central opening 116 of the ring 118 with the ring module 114 creating the closed loop of band material 108 around the wrist (or another limb portion) of the user. The ring module 114 permits the comfortable and safe positioning of the user's wrist for the application of the band and can provide visual feedback to the user about proper placement of the wrist using, for example, an RGB LED ring or other indicators. The ring module 114 provides a structure in which the band material 108 can be fed to create the looped geometry and does so in a controlled, repeatable, and even manner. This ensures successive banding operations are consistently and successfully completed. Such design is not trivial given that there is both limited space for band control in a band wrapping device 100 of the type illustrated (which is small enough to be portable) and given that there can be variations in the sizes of wrists or limbs to which the band is to be applied. A primary challenge in development of the ring module 114 was constraining and controlling the band material 108 during initial feeding of the band material 108 through the ring module 114 (so that the band material 108 does not drop or fall out of the ring module 114), while still permitting the ability for the formed looped to be reduced in size during tensioning and application. Thus, a way needed to be found to closely feed the band material 108 initially, but still allow the band material 108 to be workable after it was appropriately positioned about the ring 118.

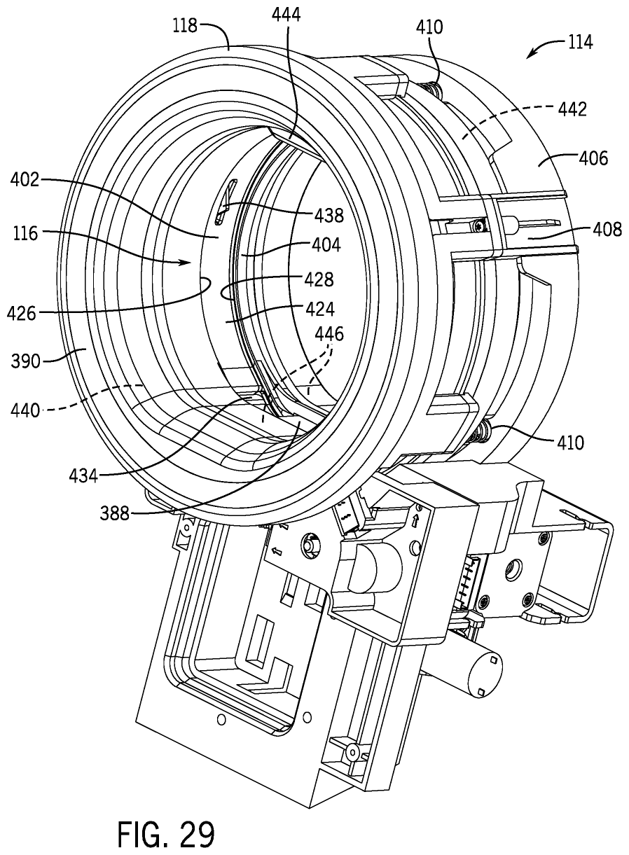

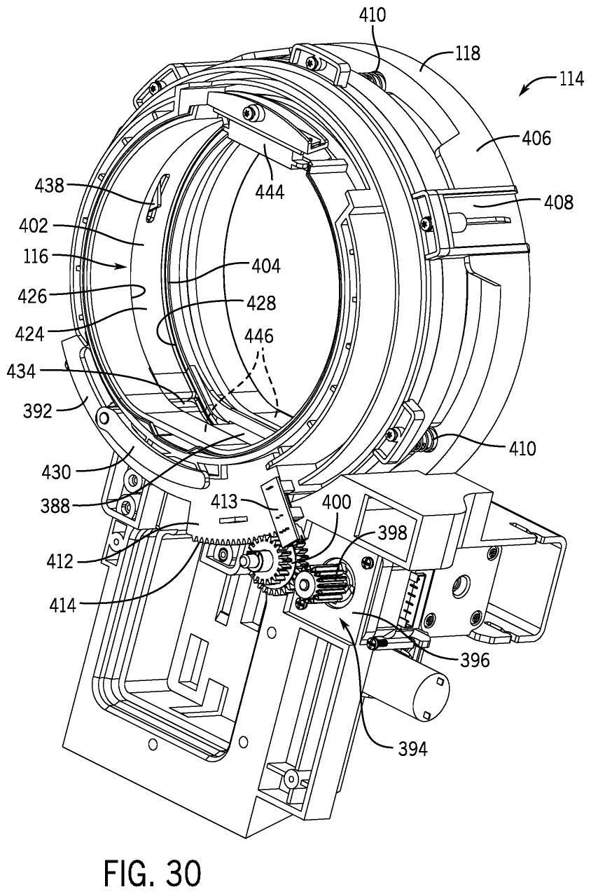

Looking now at FIGS. 29 through 35, the ring module 114 and its operation is illustrated. Comparing first FIGS. 29 and 30, FIG. 29 shows the ring module 114 apart from the rest of the band wrapping device 100, while FIG. 30 shows that same ring module 114 with part of the front ring cover sections 390 having been removed to reveal a rotatable control ring 392 and some of the housing removed. With the housing removed, a motor and gear set 394 are shown including a motor 396 having an output drive gear 398 and an intermediate gear 400 that will engage part of the rotatable control ring 392.

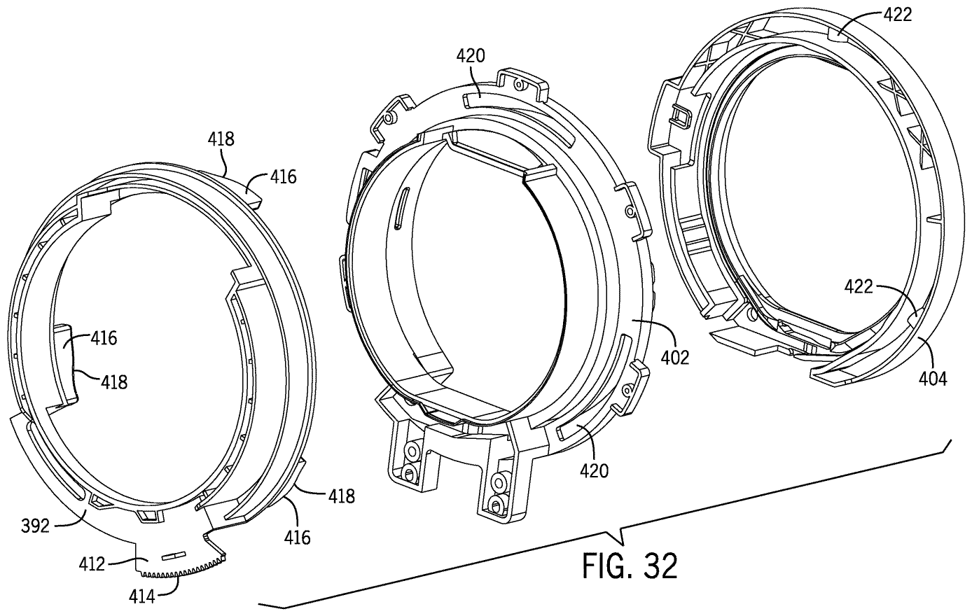

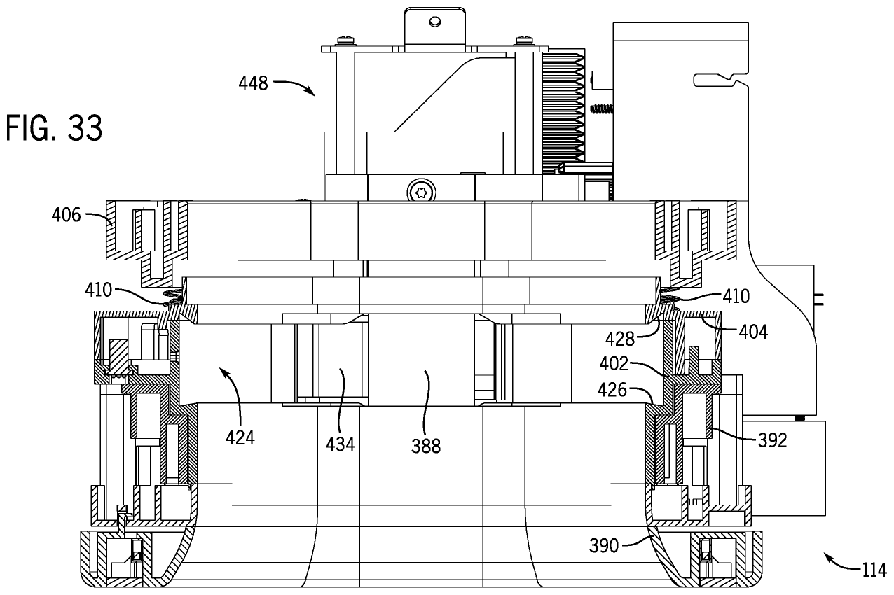

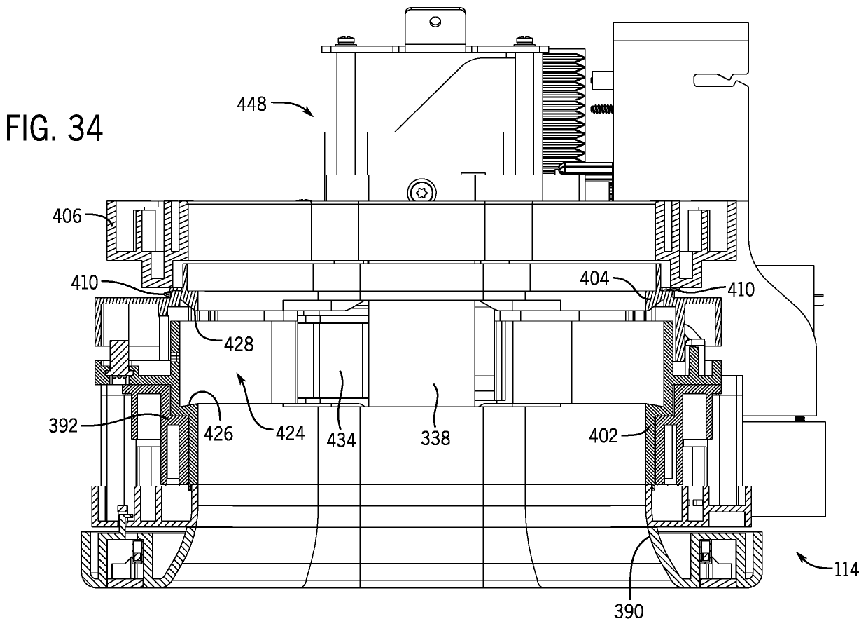

The main operational components of the ring module 114 includes three rings including the rotatable control ring 392, the first ring 402, and the second ring 404. As can be seen in the exploded view of FIG. 32, which shows just these three ring components, the rotatable control ring 392, the first ring 402, and the second ring 404 share a common central axis and are axially stacked together along that axis such that the first ring 402 is sandwiched between the rotatable control ring 392 and the second ring 404. The first ring 402 is fixed in place relative to the ring module 114 and the rest of the band wrapping mechanism 100 and this fixation can be achieved, for example, by fastening the first ring 402 to a rear support frame 406 of the ring module 114 (such as by screwing the first ring 402 at various positions into the forwardly extending posts 408 of the rear support frame 406). The rotatable control ring 392 is received axially forward of and about the first ring 402 such that portions of the outer circumference of the first ring 402 serve as a bearing surface for portions of an inner circumference of the rotatable control ring 392 as well as provides an axial stop as can be best seen in the cross sections of FIGS. 33 and 34. The second ring 404 can be axially positioned between the first ring 402 (which first ring 402 is again, fixed to the rear support frame 406) and the rear support frame 406. Notably, however, the second ring 404 is biased by one or more ring biasing elements 410 (in this exemplary embodiment, the ring biasing elements are springs) toward the first ring 402 in the axial direction. As can be best seen in FIGS. 29, 30, 31, 33, and 34, this biasing occurs by the placement of the one or more ring biasing elements 410 between an axial front side of the rear support frame 406 and a rear axial side of the second ring 404 to urge the second ring 404 axially toward the first ring 402. As will be described in the next paragraphs, that biasing force can be overcome by the rotation of the rotatable control ring 392 to effectuate a partial separation of the second ring 404 from the first ring 402 in the axial direction.

Looking more closely at the structure of the rotatable control ring 392, the rotatable control ring 392 has a ring-shaped body with a projecting wedge 412 having teeth 414 thereon. The wedge 412 extends over only a small fraction (as illustrated, approximately 15 degrees) of the circumference of the rotatable control ring 392. The teeth 414 of the rotatable control ring 392 are positioned for engagement with the motor and gear set 398 and, more particularly as illustrated, the intermediate gear 400 that is driven by the output drive gear 398 of the motor 396. The rotatable control ring 392 is constrained to a limited degree in the ring module 114 (in some cases by the attachment of the front ring cover sections 390) but is rotatably movable therein about the shared axis of the various rings. Accordingly, when the motor and gear set 394 is operated, this operation can effectuate the rotation of the rotatable control ring 392 about its central axis. The detection of the angular position of the rotatable control ring 392 can be monitored by a position sensor, such as the position sensor 430 in FIG. 30 that may monitor for the presence of a feature of the rotatable control ring 392, such as a fin, that would be observable by the sensor 430 in some possible angular positions of the ring 392, but not others.

To controllably alter the axial spacing of the second ring 404 from the first ring 402 against the biasing force, the rotatable control ring 392 also has a plurality of ramped projections 416 with ramped surfaces 418 which can be best seen in FIGS. 32 and 35. Each projection 416 is angularly spaced about an axial face of the rotatable control ring 392 that faces the first ring 402 and the second ring 404. As best seen in FIG. 32, the first ring 402 has a plurality of corresponding slots 420 aligned with the plurality of ramped projections 416 and, upon bringing the various rings together, the plurality of ramped projections 416 extend through the plurality of corresponding slots 420. As they extend through the slots 420 of the first ring 402, the ramped projections 416 project toward and can contact corresponding engagement features 422 of the second ring 404 such as little bumps or arcuate sections as depicted and as best seen in FIG. 32. The slots 420 in the first ring 402 have more angular length than the projections 416 such that the projections 416 of the rotatable control ring 392 are rotatable to a degree within the slots 420 and thus the ramped projections 416 can ride up and down the corresponding engagement features 422 to provide varied axial spacing against the biasing force of the one or more ring biasing elements 410 effectuating the axial displacement of the second ring 404.

It is contemplated that the location of the ramped projections 416 could be differently positioned or configured than illustrated but achieve a similar effect. For example, instead of being located on the rotatable control ring 392, the plurality of ramped projections 416 could be placed on the second ring 404 and extend back to engage the rotatable control ring 392 through the slots 420 of the first ring 402 and interact with features on the rotatable control ring 392. Still further, the projections 418 could be mixed across both the rotatable control ring 392 and the second ring 404 and/or their engagement could be to meet in the middle rather than having one alone primarily extend to the other.

With the above axial positionability of the second ring 404 relative to the first ring 402 having been appreciated and as can be best seen in the cross-sectional views of FIGS. 33 and 34, it is now explained that the first ring 402 and the second ring 404 together define a channel 424 of variable width, which width at a particular moment in time can established by the interaction of the rotatable control ring 392 with the second ring 404. As best seen in the cross-sectional views of FIGS. 33 and 34, the first ring 402 has a first ring edge 426 partially defining the channel 424 for a band material ring path through the ring module 114. The second ring 404 has a second ring edge 428 opposing the first ring edge 426 in which the second ring edge 428 also partially defines the channel 424 for the band material ring path through the ring module 114.

As illustrated and best seen in FIGS. 33 and 34, the first ring edge 426 and the second ring edge 428 provide undercuts. The undercuts can provide a dovetail shape to help retain the band material 108 when the first ring edge 426 and the second ring edge 428 are close together (as in FIG. 33) and prevent the band material 108 from falling out of the channel 424 in a radial direction in at least some of the closer axial spacings of the first ring edge 426 and the second ring edge 428 based on and relative to the width of the band material 108. However, upon further axially spacing the first ring edge 426 and the second ring edge 428 by overcoming the biasing force (as in FIG. 34), the band material 108 is allowed to radially exit the channel 424 for the band material ring path, such as may be helpful during tensioning of the band material 108.

From the above, it can now be understood that the second ring 404 is movable with respect to the first ring 402 to alter an axial spacing of the first ring edge 426 and the second ring edge 428 thereby altering a width of the channel 424 of the band material ring path. The altering of the width of the channel 424 between the closed position shown in FIG. 33 and the open position shown in FIG. 34 can be effectuated by the rotation of the rotatable control ring 392 relative to the first ring 402 and second ring 404 via the motor and gear set 394. Upon rotation of the rotatable control ring 392 from a closed path rotational position (as depicted in FIG. 33) to an open path rotational position (as depicted in FIG. 34), the angular placement of the projections 416 on the rotatable control ring 392 are altered to change the axial position of the second ring 404 relative to the first ring 402 against the biasing force applied to the second ring 404. If the rotatable control ring 392 rotates from the open path rotational position back to the closed path rotational position, then the different angular placement of the ramped projections 416 on the rotatable control ring 392 and their engagement with the corresponding engagement features 422 on the second ring 404 permits the second ring 404 to be displaced back towards the first ring 402 axially, reducing the spacing of the first ring edge 426 and the second ring edge 428 and narrowing the channel 424 again.

With reference to FIGS. 30 and 35, the rotatable control ring 392 not only is able to be rotated to alter the axial position of the second ring 404 via the ramped projections 416, but also includes a linkage arm 430 that connects to a shaft 432 that supports a wristband clamp 434 (as well as a cutting block 436). When the rotatable control ring 392 is rotated counterclockwise about its central axis, the wristband clamp 434 travels with the rotatable control ring 392 and can be used to pinch or release an end of the band material 108 during the tensioning process. This pinch position can be seen specifically in FIGS. 27A-27G on the top side of the figures as, just prior to the cutting and sealing process shown in those figures, the wristband clamp 434 is rotated to a pinch position to hold the end of the band material 108 during tensioning against the anvil 388. When rotated in the clockwise direction, the wristband clamp 434 would be drawn away from the anvil 388 and the band material 108 released.

So notably, the rotation of the rotatable control ring 392 can both alter the width of the channel 424 and can pinch or release the band material using the wristband clamp 434. The ring module 114 and the rotatable control ring 392 are designed and structured so that both happen at the appropriate times for the desired band application process. Put differently and stated more particularly, when the rotatable control ring 392 is in the clockwise-most position relative to the orientation in FIG. 30, this position corresponds to both the release position of the wristband clamp 434 and the closed path rotational position in which the channel 424 is narrowest. This is desirable as, during the initial feeding of the band material 108 through the channel to establish the loop, the band material 108 is to be retained in the channel 424 so that the band material 108 does not drop out of the channel 424 and needs to be able to be fed in as far as possible to create a region of overlap under the loop without the wristband clamp 434 having yet been pinched. And then, when the rotatable control ring 392 is in the counter-clockwise-most position relative to the orientation in FIG. 30, this position corresponds to both the pinch position of the wristband clamp 434 and the open path rotational position in which the channel 424 is widest. This is desirable as, once the band material 108 has fully been fed into place, the band material 108 should be pinched by the wristband clamp 434 and the channel 424 simultaneously (or near simultaneously) opened to permit the band material 108 to exit the channel 424 radially as part of the tensioning process.

The ring module 114 can contain various other structures (not all of which will be described here) that can further facilitate the operation of the ring module 114.

For example, and as best seen in FIGS. 29, 30, and 31, there can be a gravity bias flag and sensor set 438 positioned within the channel 424 of the band material ring path that detects the presence of the band material 108 within the channel 424 of the band material ring path at that location. During the feeding of the band material 108 through the channel to form the loop this gravity bias flag and sensor set 438 can help to establish or confirm the presence (or absence) of the band material 108 in the channel 424 at this location by the detected position of the flag which can be indicative that the band material 108 has either been successfully fed to this point or has in some way failed in being fed (which detected failure could be used to halt further operation or provide an error message to the end user). In some forms, rather than having a gravity bias flag and sensor set 438 as depicted, it is contemplated that a sensor could instead be positioned at the bottom of the ring 118 in the channel 424. Moreover, at such position, the band detection sensor may not rely on gravity, but instead may be sprung or biased into an extended position and then displaced when the band material 108 passes over the band position sensor.

Additionally, there can be various other indicators available as part of the ring module 114 and which are attached to or viewable from the housing, that provides instructions or prompts to the user and or provides the user with other indications. For example, one or more indicators could provide prompts for a user operation of the ring module such as an indication that a user is to insert a wrist at a particular time or location. As one example of this, there can be a light ring 440 around the central opening 116 of the ring 118 that varies in color to indicate the current availability of the band wrapping device 100 for use. As depicted the light ring 440 can be positioned beneath the housing surface and the light viewable through the housing. For example, a green lit ring may indicate the band material 108 is fed and is ready to be tensioned, another color may indicate the machine is in use, and red lit ring may indicate that the machine 100 is not available for a variety of reasons (error in operation, lack of band material, and so forth). It is contemplated that, at least in some situations, the one or more indicators include an LED animation, pattern, or color that provide the prompts for the user operation of the ring module. These could include directional or sequenced lights for instance to indicate a position for wrist placement.

Still further, there can be operational sensors as part of the ring module 114 to guide the user to put the wrist in the correct location in the central opening 116 of the ring module 114 and to detect that presence of the wrist and that it is correctly positioned. For example, a sensor, such as a time-of-flight sensor 442 (dashed lines to where the sensor would be generally paced), may be positioned in the ring module 114 for detecting a presence of the object (i.e., the wrist) within the center opening 116 of the ring module 114. Upon detecting an object within the center opening 116 of the ring module 114, an LED light 44 at the top of the ring 118 can project a light/silhouette of a wristband onto the wrist indicating where the band will be applied on the wrist. The bottom of the ring module 114 can include one or more capacitive touch pads 446 that are used to detect the positioning of the wrist close to the bottom of the ring 118 (which is the preferred location for the wrist to be at the start of tensioning). In some forms of the device 100, the ring module 114 is configured to perform a tensioning operation only when both capacitive touch pads 446 are contacted by the wrist and when the time-of-flight sensor 442 also detects the object within the center opening 116 of the ring module 114. This ensures correct placement of the wrist during the operation of the machine and prevents erroneous or improper use of the machine.

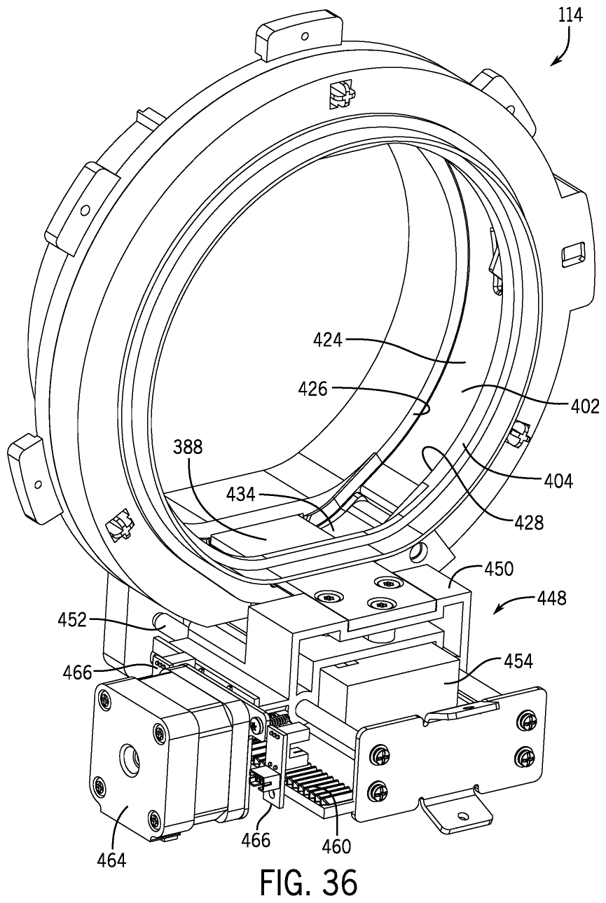

Finally, with reference to FIGS. 36 through 38, the anvil 388 is shown in greater detail as part of a greater anvil subassembly 448. While the anvil 388 has been mentioned at points above briefly with respect to the sealer module 112, with which it also interacts, the structure and operation of the anvil 388 is explained in greater detail at this point.

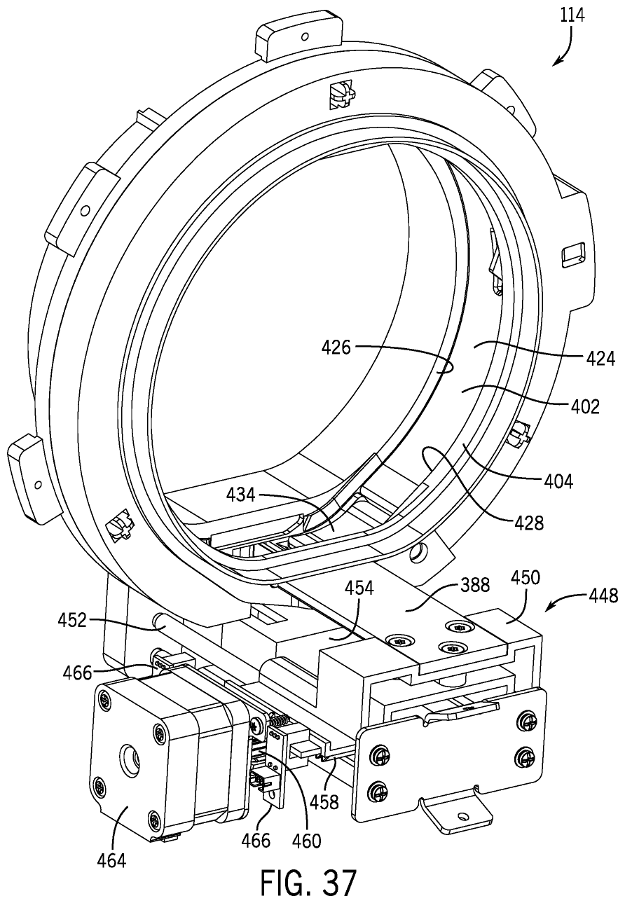

Looking at FIG. 38, the anvil subassembly 448 is shown apart from the rest of the device 100. The anvil subassembly 448 includes the anvil 388 which can be seen in this view as being generally platelike. The anvil 388 is attached to a slider plate 450 which is received on a set of parallel shafts 452 along which the slider plate 450 and, hence, the anvil 388 can travel. Beneath the slider plate 450 there is a heat element cover plate 454 which is also received on a set of parallel shafts 456 to those supporting the slider plate 450 carrying the anvil 388. There is a slider plate toothed rack 458 facing downward on the slider plate 450 and a heat element cover plate toothed rack 460 facing upward on the heat element cover plate 454. Both the slider plate toothed rack 458 and the heat element cover plate toothed rack 460 engage a driven pinion gear 462 by an anvil motor 464 as depicted in FIG. 37 such that they effectively for a pair of rack and pinion type drives for dual opposite linear actuation of the slider plate 450 and associated anvil 388 and the heat element cover plate 454. Given the oppositional arrangement of the racks 458 and 460, when one of the slider plate 450 (with associated anvil 388) or the heat element cover plate 454 is advanced, the other one of the two are retracted.

There can also be positional sensors such as sensors 466 to determine the location of the anvil 388 by detecting the presence or absence of a part of the associated slider housing 450.

During operation of the band wrapping machine 100, this anvil 388 will be actuated or moved between the anvil sealing position of FIG. 36 and an anvil retracted position of FIG. 37 at the bottom side of the ring 118 of the ring module 114. During a tensioning, sealing, and cutting operation of the band material 118 by the ring module 114, the anvil 388 is positioned in the anvil sealing position by advancement of the slider plate 450 towards the ring 118 such that the sealer module 112 can be engaged with the anvil 388 as shown in FIGS. 27A through 27G. During this advancement of the anvil 388, the heat element cover plate 454 is retracted by the action of the opposing rack and pinion setup. After the tensioning, sealing, and cutting operation of the band material 108 is complete, the anvil 388 is movable to the anvil retracted position by translating the slider plat 450 backward to permit the band material 118 formed into the loop to be removed from the ring module 114. In retracting the anvil 388, this also causes the advancement of the heat element cover plate 454. This advancement of the heat element cover plate 454 covers the engagement end 308 of the sealer module 112 (which may still be hot from operation) and prevents the user from contacting that engagement end 308 while the anvil 388 is retracted.

### Overall Operation of the Band Wrapping Device

With the various constituent components having been described individually and in more specific detail, the overall operation of the band wrapping device 100 will be briefly summarized to highlight the interaction of the various components.

In general operation, a source of the band material 108 should be present in the device 100. In the instant embodiment, this occurs by inserting a cassette 104 into the cassette tray 106. Preparatory to this step, the cassette housing 132 may be opened to replace the spool 134 and/or the length of band material 108 on the spool 134. Upon loading, the teeth 158 on the axial end 154 of the hub 144 of the spool 134 engage the spool drive gear 168 so that the rotation of the spool 134 may be controlled. During the insertion, the band clamp 176 is also actuated by engagement with the device 100 in some fashion to release the band material from the band material passage 170 at the exit 160 of the cassette 104 and to permit the band material 108 to be fed from the cassette 104. Further, during insertion, the idler roller 184 of the cassette 104 is placed in opposition to the cassette roller 218 of the feed mechanism 206 of the band transport mechanism 110.

With reference to FIGS. 21A through 21D described above, at this point the band material 108 is fed through the band transport mechanism 110 and up into the ring module 114. As described above, the feeding involves forward feeding the band material 108 through the band material 108 between the cassette roller 218 and the idler roller 184, through the feed rollers 212 and 214, through the slack ballast pocket 208, and through the band position roller and tensioner set 210 to the band output channel 204 of the band transport mechanism path 200. As described above, after initial feeding of the band material 108, the slack in the band material 108 is initially removed by advancing the band position roller and tensioner set 210 while the feed mechanism 206 remains undriven. When the tension roller 246 stops rotating, this indicates that the band material 108 is no longer traveling past the tension roller 246 and the slack has been removed from the slack ballast pocket 208. At this point, the feed mechanism 206 forward feeds some additional band material into the slack ballast pocket 208 to establish a pre-defined amount of slack in the ballast pocket 208.

At this stage, the band material 108 can be uniformly fed forward into the ring module 114 to preestablish the loop. This action all occurs with the anvil 388 in the extended position. The band material 108 is fed forward initially with the channel 424 in the closed path rotational position in which the first ring 402 and the second ring 404 are biased together to keep the first ring edge 424 and the second ring edge 426 close together to provide a path to guide the band material 108 to travel through the ring module 114 without falling out. At this point, the band material 108 is fed to and slightly past the wristband clamp 434 to form an overlapping region of band material 108 that can be subject to heating for closure of the band material 108 for forming the loop. At this point, the rotatable control ring 392 can be rotated to effectuate the wristband clamp 434 and hold the terminal end of the band material 108 in place and to open the channel 424 of the ring module 114 to the open path rotational position.

The band wrapping device 100 now may wait for a wrist, other limb portion, or other object to be detected in the central opening 116 of the ring 118. As described above, sensors like a time-of-flight sensor and/or capacitive sensors can be used to determine such a wrist is present and appropriately positioned within the central opening 116. There can also be guidance mechanism such as LED indicators, silhouettes casted, and so forth, to guide or instruct the user as to appropriate placement of their wrist for operation.

With the wrist detected, the band tensioning process can occur with the band material 108 being tensioned backward through the band transport mechanism 110. As this occurs, spool 134 of the cassette 104 is also driven in reverse by the spool drive motor 162 to take back up some portion of the band material 108. As this tensioning process occurs, the band material 108 in the loop of the ring module 114 can be closed and sized around the wrist of the user since the channel 424 is opened to permit the radius of the band material 108 in the loop to be reduced and the terminal end of the band material 108 is pinched by the wristband clamp 434. Once the band material 108 is drawn against the wrist of the user (or other object receiving the band), upon further pulling, the band material 108 not further travel along the upper portion of the band transport path 200 (that is, the portion after the band position roller and tension roller set 210). When this occurs, the tension roller 246 stops rotating and, upon this detection, the reverse feed of the band transport mechanism 110 is halted. Because there is some small delay between the detection of the stopped rotation of the tension roller 246 and the halting of the reverse feed, a portion of the pre-established tension in the slack ballast pocket 208 is consumed during this delay. But for this engineered slack consumption, the band application on the wrist could be too tight and uncomfortable on the user if the band material 108 continued to be drawn taut for even some small length of time without any slack to be consumed.

Once the tensioning has stopped, then the band material 108 can be heated and sealed using the sealer module 112 as illustrated in FIGS. 27A through 27G. As described above, the band material 108 is first clamped, and then heat sealed to itself to form the loop and severed from the rest of the band material 108. At this point, the anvil 388 can be retracted (and the heat element cover plate 454 advanced) to permit the user to remove their wrist with the loop applied to it from the ring module 114. The band material 108 can again undergo the process above including the removal of slack from the slack ballast pocket 208, the creation of a predefined amount of slack in the slack ballast pocket 208, rotating the rotatable control ring 392 to the closed path rotational position and feeding the band material 108 into the channel 424, advancing the anvil 388 and pinching the band material at the wristband clamp 434 while opening the channel 424 by rotation of the rotatable control ring to the open path rotational position. At this point with the band material 108 again positioned for application, the device 100 is again set for automated application of a looped band onto the wrist of a user.

Periodically, the band wrapping device 100 may run out of band material 108 and this can be detected by the device 100 in various ways such as, for example, a particular sensor along the band path not detecting the presence of the band material (for example, by some of the photo optic sensors or by the gravity bias flag). On those situations, the device 100 may indicate that the device 100 is out of material by a noise, visual indication, or the like, and the remaining band material rewound onto the cassette 104 by reverse feed and the spool drive motor 162. At this point, the cassette 104 can be removed, opened, and the spool 134 replaced or length of band material 108 replenished. Upon being reloaded, the band material 108 can then be advanced as described above.

Thus, a band wrapping device 100 is presented that is used to form a loop and apply a band to a user in an automated fashion. As it is automated, the device 100 can reduce the physical contact between a person requiring a wristband and the person applying them. It also can reduce the amount of waste, as there is no residual tail to be cut off as is more commonly found in separate standalone bands that must be sized to accommodate the largest possible wrist. And finally, because the device 100 is automated, the requirements for staffing can be greatly reduced and one individual could potentially monitor an entire bank of such band wrapping devices 100.

As noted above, it should be appreciated that various other modifications and variations to the preferred embodiments can be made within the spirit and scope of the invention. Therefore, the invention should not be limited to the described embodiments. To ascertain the full scope of the invention, the following claims should be referenced.

1.-14. (canceled)

15. A band transport mechanism for a band wrapping device for controlling movement of a length of band material along a band transport mechanism path from a source of band material to a band application mechanism, the band transport mechanism also selectively providing tension to length of band material during a tensioning process for the band application mechanism, the band transport mechanism comprising:
a feed mechanism comprising a pair of feed rollers driven by a feed mechanism stepper motor in which a portion of the band transport mechanism path extends between the pair of feed rollers;
a band position roller and tensioner set positioned between the feed mechanism and an exit of a band output channel at an end of the band transport mechanism path, the band position roller and tensioner set comprising a band position roller driven by a band position roller stepper motor and further comprising a tensioner mechanism including a tension roller biased toward the band position roller under an applied tensioning force;
a slack ballast pocket between the feed mechanism and the band position roller and tensioner set, the slack ballast pocket providing a section of the band transport mechanism path that is variable in length, the slack ballast pocket having a pair of opposing slack ballast pocket surfaces that define a longest path length for the band transport mechanism path in which a maximum slack is provided and a shortest path length for the band transport mechanism path in which no slack is provided;
wherein, under the applied tensioning force on the tension roller, a clamping force is applied between the band position roller and the tension roller such that, when the band position roller is driven, a rotation of the tension roller is effectuated upon transport of the band material until the clamping force is insufficient and the tension roller stops rotating, thereby causing the band position roller to slip with respect to the band material.

16. The band transport mechanism of claim 15, wherein the feed mechanism further comprises a feed roller belt that links the feed mechanism stepper motor to at least one the pair of feed rollers to drive the rotation of the at least one of the pair of feed rollers.

17. The band transport mechanism of claim 15, wherein the feed mechanism further comprises, apart from the pair of feed rollers, a cassette roller driven by the feed mechanism stepper motor, the cassette roller being configured to oppose an idler roller provided on a structure of a cassette.

18. The band transport mechanism of claim 17, wherein the feed mechanism further comprises a feed roller belt that links the feed mechanism stepper motor to at least one of the pair of feed rollers to drive the rotation of the pair of feed rollers and the feed mechanism further comprises a cassette roller belt that links a rotation of the pair of feed rollers to a rotation of the cassette roller belt.

19. The band transport mechanism of claim 17, further comprising a photo-interrupter sensor positioned along the band transport mechanism path between the cassette roller and the pair of feed rollers, the photo-interrupter sensor being configured to detect an edge of the length of band material.

20. The band transport mechanism of claim 15, wherein a spacing between the pair of opposing slack ballast pocket surfaces positionally varies over a portion of a length the band transport mechanism path within the slack ballast pocket.

21. The band transport mechanism of claim 20, wherein the spacing between the pair of opposing slack ballast pocket surfaces increases from the feed mechanism to a maximum spacing within the slack ballast pocket and then decreases from the maximum spacing to the band position roller and tensioner set.

22. The band transport mechanism of claim 15, wherein the band position roller is driven by the band position roller stepper motor via a drive train of gears.

23. The band transport mechanism claim 15, wherein the applied tensioning force between the tension roller and the band position roller is adjustable.

24. The band transport mechanism of claim 23, wherein the tensioner mechanism sets the applied tensioning force between the tension roller and the band position roller by adjustment of a rotatable thumbwheel having an axial end of varying length that alters the tensioning applied by a biasing mechanism to the tension roller.

25. The band transport mechanism of claim 15, wherein a rotation or lack thereof of the tension roller is detectable and, when the band position roller is driven and the tension roller is detected as not rotating, the band transport mechanism halts driving of the band position roller.

26. The band transport mechanism of claim 25, wherein the band position roller and tensioner set and a capacity of the tension roller to reflect a movement or lack thereof of the band material, in conjunction with the ballast slack pocket, permits the band transport mechanism to account for an unknown amount of slack along the band transport mechanism path.

27. The band transport mechanism of claim 25, wherein in a slack removal operation, the pair of feed rollers are held stationary and the band position roller is driven to move the length of band material forward to cause the band material in the slack ballast pocket to follow the shortest path length within the slack ballast pocket, until all slack is removed and a lack of movement of the tension roller is detected which thereby results in halting driving of the band position roller.

28. The band transport mechanism of claim 25, wherein in a band application operation, the pair of feed rollers initially advances the length of band material into the slack ballast pocket to create a pre-established amount of slack.

29. The band transport mechanism of claim 28, wherein in the band application operation, after the pre-established amount of slack has been established in the slack ballast pocket, the tension roller and the pair of feed rollers drive the length of band material in a reverse direction to create a tension in the band material and wherein, upon exceeding the clamping force of the tension roller and the tension roller stops rotating and, subsequently, the tension roller and the pair of feed rollers are halted, any delay between a detection that the tension roller has stopped rotating and halting of the pair of feed rollers is accounted for by only a partial consumption of the slack in the slack ballast pocket.

30. The band transport mechanism of claim 15, wherein the band position roller and tensioner set further comprises a magnetic encoder wheel rotatably connected with the tension roller and further comprising a Hall effect sensor capable of detecting travel of the band material via a monitoring of the rotation of the magnetic encoder wheel on the tension roller.

31.-62. (canceled)

63. A band wrapping device for forming a length of band material into a loop, the band wrapping device comprising:
a band transport mechanism having a band transport mechanism path running therethrough along which a plurality of rollers is positioned to advance or reverse the length of a band material therethrough;
a ring module receiving the length of band material from the band transport mechanism, the ring module forming the length of band material into the loop around an object received within a center opening of the ring module; and
a sealer module that clamps, seals, and cuts the length of band material to close the loop and separate it from a remainder of the length of band material.

64. The band wrapping device of claim 63, wherein the band transport mechanism path runs from a cassette tray for receiving a cassette providing the length of band material to the ring module.

65. The band wrapping device of claim 63, wherein the band transport mechanism comprises:
a feed mechanism comprising a pair of feed rollers driven by a feed mechanism stepper motor in which a portion of the band transport mechanism path extends between the pair of feed rollers;
a band position roller and tensioner set positioned between the feed mechanism and an exit of a band output channel at an end of the band transport mechanism path, the band position roller and tensioner set comprising a band position roller driven by a band position roller stepper motor and further comprising a tensioner mechanism including a tension roller biased toward the band position roller under an applied tensioning force;
a slack ballast pocket between the feed mechanism and the band position roller and tensioner set, the slack ballast pocket providing a section of the band transport mechanism path that is variable in length, the slack ballast pocket having a pair of opposing slack ballast pocket surfaces that define a longest path length for the band transport mechanism path in which a maximum slack is provided and a shortest path length for the band transport mechanism path in which no slack is provided;
wherein, under the applied tensioning force on the tension roller, a clamping force is applied between the band position roller and the tension roller that, when the band position roller is driven, effectuates a rotation of the tension roller upon transport of the band material until the clamping force is insufficient and the tension roller stops rotating, thereby causing the band position roller to slip with respect to the band material.

66. The band wrapping device of claim 63, wherein the sealer module comprises:
a location block assembly translatable to move an engagement end of the sealer module from a retracted position to a band closure position by an actuation mechanism;
wherein the location block assembly carries a plurality of components that are movable with the location block assembly and actuatable by the actuation mechanism, the plurality of components including:
a primary clamp having a primary clamp surface;
a heater element having a heatable face; and
optionally a cutter mechanism including a blade assembly;
wherein, in the retracted position, the primary clamp surface is positioned at and biased towards a leading-most end of the engagement end of the sealer module to provide that the primary clamp surface first contacts the band upon actuation of the location block assembly towards the band closure position and is deflectable from the leading-most end of the engagement end under an applied pressure;
wherein the heatable face is heatable and displaceable to contact a band material to effectuate sealing of the band material to itself by heating and applying a pressure on the band material, wherein the heatable face is biased towards a leading-most end of the engagement end of the sealer module, and wherein, in the retracted position, the heatable face is positioned behind the primary clamp surface along a direction of translation of the location block assembly relative to the engagement end.

67. The band wrapping device of claim 63, the ring module comprising:
a first ring having a first ring edge partially defining a channel for a band material ring path through the ring module;
a second ring having a second ring edge opposing the first ring edge, the second ring edge partially defining the channel for the band material ring path through the ring module, the second ring being movable with respect to the first ring to alter an axial spacing of the first ring edge and the second ring edge thereby altering a width of the channel of the band material ring path.
